(19) United States
(12) Patent Application Publication
(10) Pub. No.: US 2026/0082200 A1
(43) Pub. Date: Mar. 19, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: RYOYA KAWAI, Kanagawa (JP)

(21) Appl. No.: 19/323,455

(22) Filed: Sep. 9, 2025

(30) Foreign Application Priority Data
Sep. 13, 2024 (JP) 2024-159071

(51) Int. Cl. H04W 8/00; H04W 48/20

(52) U.S. Cl. CPC H04W 8/005; H04W 48/20

(57) ABSTRACT

A method for controlling a first information processing apparatus including a predetermined application program and an operating system includes transmitting an instruction to the operating system to establish a connection between a communication apparatus and the first information processing apparatus, displaying a screen for disabling a mirroring function, the mirroring function being a function for displaying a screen based on screen information transmitted by the first information processing apparatus and for controlling the first information processing apparatus on a display unit of a second information processing apparatus different from the first information processing apparatus, and transmitting in a case where the connection between the communication apparatus and the first information processing apparatus is established based on the instruction, connection information for connecting to an access point, the access point being external to both the first information processing apparatus and the communication apparatus, to the communication apparatus via the established connection.

### BACKGROUND

### Field of the Technology

The present disclosure relates to an information processing apparatus, a control method, and a storage medium.

### Description of the Related Art

A known configuration involves an information processing apparatus such as a smartphone or the like transmits information for connecting to an access point to a communication apparatus such as a printer or the like, whereby the communication apparatus connects to the access point using the information.

Japanese Patent Laid-Open No. 2016-127545 describes a technique in which an information processing apparatus transmits information to a communication apparatus, thereby setting a connection mode that determines a connection form between the information processing apparatus and the communication apparatus in the communication apparatus.

Incidentally, with the prevalence of a form in which information for connecting to an access point is transmitted to a communication apparatus, an improvement in the usability of an application program that executes a process for transmitting information for connecting to an access point to a communication apparatus is requested.

### SUMMARY

The present disclosure is directed to improving the usability of an application program that supports a mirroring function and performs a process for transmitting information for connecting to an access point to a communication apparatus.

According to an aspect of the present disclosure, a method for controlling a first information processing apparatus including a predetermined application program and an operating system, includes transmitting, by the predetermined application program, an instruction to the operating system to establish a connection between a communication apparatus and the first information processing apparatus, displaying, by the predetermined application program, a screen for disabling a mirroring function, the mirroring function being a function for displaying a screen based on screen information transmitted by the first information processing apparatus and for controlling the first information processing apparatus on a display unit of a second information processing apparatus different from the first information processing apparatus, and transmitting, by the predetermined application program, in a case where the connection between the communication apparatus and the first information processing apparatus is established based on the instruction, connection information for connecting to an access point, the access point being external to both the first information processing apparatus and the communication apparatus, to the communication apparatus via the established connection.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a communication system.

FIG. 2 is a diagram illustrating examples of configurations of a terminal apparatus and a communication apparatus.

FIGS. 3A and 3B are a flowchart illustrating an example of processing executed using a first app by the terminal apparatus.

FIG. 4 is a diagram illustrating an example of a screen for a direct connection.

FIG. 5 is a diagram illustrating an example of a password input screen.

FIG. 6 is a diagram illustrating an example of a screen for confirming a password.

FIG. 7 is a flowchart illustrating an example of processing executed using the first app by the terminal apparatus.

FIG. 8 is a diagram illustrating an example of a confirmation screen.

FIG. 9 is a flowchart illustrating an example of a connection process in a connection setting mode.

FIG. 10 is a diagram illustrating an example of a screen indicating that a communication apparatus is being searched for.

FIGS. 11A and 11B are diagrams illustrating another example of the screen indicating that a communication apparatus is being searched for.

### DESCRIPTION OF THE EMBODIMENTS

### First Embodiment

A description is given of an information processing apparatus and a communication apparatus included in a communication system according to a first embodiment. The information processing apparatus is also referred to as a "terminal apparatus". Although in the present embodiment, a smartphone is illustrated as an example of the information processing apparatus, the present disclosure is not limited to this. As the information processing apparatus, various apparatuses such as a personal computer (PC), a tablet terminal, a personal digital assistant (PDA), a digital camera, and the like are applicable. In the present embodiment, a printer is illustrated as an example of the communication apparatus. The printer may be an inkjet printer that performs printing using ink, or may be a laser beam printer that performs printing using toner. The printer may be a full-color printer capable of color printing, or may be a monochrome printer incapable of color printing and capable of monochrome printing. In the present embodiment, the communication apparatus is not limited to a printer. Any apparatus may be applied as the communication apparatus so long as the apparatus can wirelessly communicate with the information processing apparatus. As the communication apparatus, for example, a copying machine, a facsimile apparatus, a scanner, a smartphone, a laptop PC, a tablet terminal, a PDA, a digital camera, a music reproduction device, a television, a smart speaker, a robotic vacuum cleaner, an automatic cooker, a refrigerator, and the like. Additionally, the communication apparatus is also applicable to a multifunction peripheral having a plurality of functions such as a copy function, a fax function, a print function, and the like.

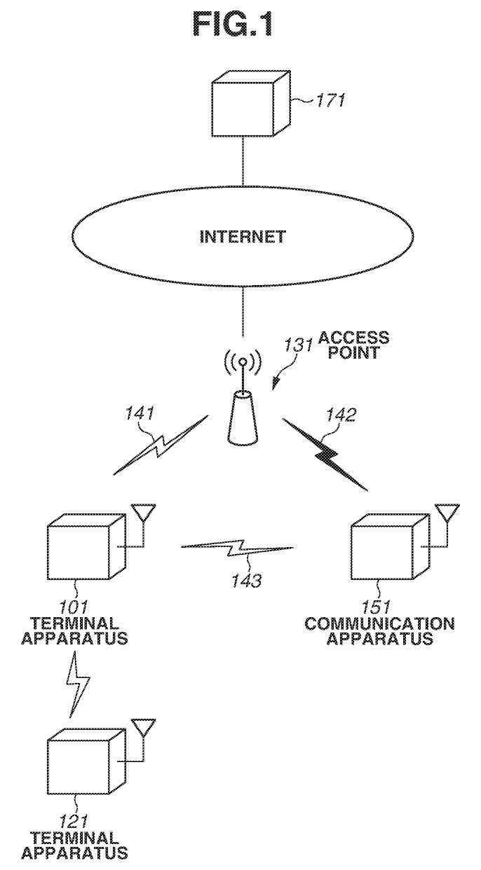

First, a system configuration for achieving the present embodiment is described. FIG. 1 is a diagram illustrating an example of the configuration of the communication system according to the present embodiment. This system includes a communication apparatus 151, a terminal apparatus 101, a terminal apparatus 121, an access point (AP) 131, and an external server 171.

The terminal apparatus 101 is the information processing apparatus according to the present embodiment. The communication apparatus 151 is the communication apparatus according to the present embodiment. The AP 131 is an access point started by an external apparatus present outside the terminal apparatus 101 and outside the communication apparatus 151. For example, the external apparatus is a local area network (LAN) router. The external server 171 is a server capable of providing a service via the Internet to an apparatus connected to the AP 131.

In the situation where the communication apparatus 151 and the terminal apparatus 101 are connected to the AP 131, a LAN formed by the AP 131 includes the AP 131, the communication apparatus 151, and the terminal apparatus 101. On the other hand, a wide area network (WAN) includes the AP 131 and the external server 171.

In the present embodiment, if an infrastructure connection is established, the terminal apparatus 101 can communicate with the communication apparatus 151 via the AP 131. Further, if a direct connection is established, the terminal apparatus 101 can directly communicate with the communication apparatus 151 not via the AP 131. In the following description, a connection with an AP is equivalent to a connection with a network formed by the AP. Alternatively, a single external apparatus may start a plurality of APs, and the single external apparatus may be able to simultaneously form a plurality of networks.

In the present embodiment, a connection 141 between the terminal apparatus 101 and the AP 131 and a connection 142 between the communication apparatus 151 and the AP 131 are connections using a communication method based on the Institute of Electrical and Electronics Engineers (IEEE) 802.11 series standard. Specifically, the communication method based on the IEEE 802.11 series standard is Wireless Fidelity (Wi-Fi) (registered trademark). A connection 143 between the terminal apparatus 101 and the communication apparatus 151 is also a connection using the communication method based on the IEEE 802.11 series standard. However, the communication method used for the connection 143 is not limited to this form, and for example, may be Bluetooth® Low Energy, Bluetooth® Classic, Wi-Fi Aware, near-field communication (NFC), or the like. The AP 131 and the external server 171 can communicate with each other via the Internet, and in the state where the AP 131 is connected to the Internet, an apparatus (the terminal apparatus 101 or the communication apparatus 151) connected to the AP 131 can also use the Internet. The connection 141 between the terminal apparatus 101 and the AP 131 and the connection 142 between the communication apparatus 151 and the AP 131 may be connections using a wired LAN.

The terminal apparatus 121 is an information processing apparatus similar to the terminal apparatus 101 and is an example of another information processing apparatus. The terminal apparatus 101 can wirelessly communicate with the terminal apparatus 121.

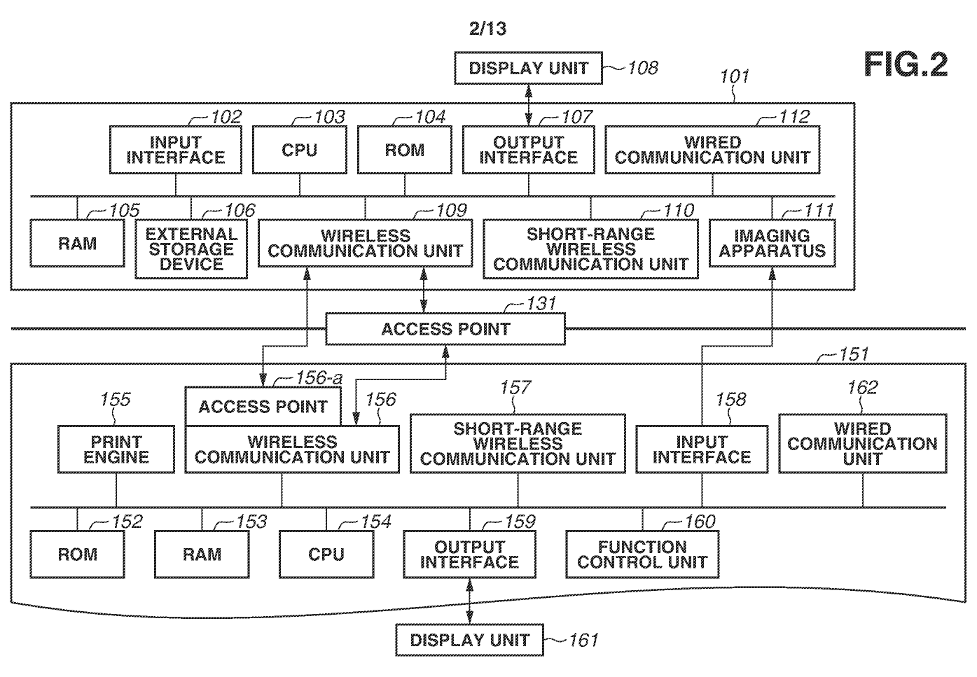

Next, with reference to a block diagram in FIG. 2, a description is given of the configurations of the information processing apparatus according to the present embodiment and the communication apparatus capable of communicating with the information processing apparatus according to the present embodiment. Although the present embodiment is described taking the following configurations as examples, the present embodiment is applicable to an apparatus capable of communicating with the communication apparatus, and functions are not particularly limited as illustrated in FIG. 2.

The terminal apparatus 101 includes an input interface 102, a central processing unit (CPU) 103, a read-only memory (ROM) 104, a random-access memory (RAM) 105, an external storage device 106, an output interface 107, a display unit 108, a wireless communication unit 109, a short-range wireless communication unit 110, an imaging apparatus 111, a wired communication unit 112, and the like. The CPU 103, the ROM 104, the RAM 105, and the like form a computer of the terminal apparatus 101.

The input interface 102 is an interface for receiving the input of data or an operation instruction from a user and is composed of a physical keyboard, a button, a touch panel, and the like. Alternatively, a form may be employed in which the output interface 107 and the input interface 102 are the same component, and the same component outputs a screen and receives an operation from the user.

The CPU 103 is a system control unit and controls the entirety of the terminal apparatus 101. In the present embodiment, the CPU 103 executes control of the display content (display control) of the display unit 108, and the like.

The ROM 104 stores fixed data such as control programs executed by the CPU 103, a data table, an operating system (hereinafter referred to as "OS") program, and the like. In the present embodiment, the control programs stored in the ROM 104 control the execution of software such as scheduling, a task switch, an interrupt process, and the like under control of the embedded OS stored in the ROM 104. In the present embodiment, the ROM 104 stores a predetermined application program (app) for controlling the communication apparatus 151. In other words, an application program is application software. For example, the predetermined app is externally installed on the terminal apparatus 101 by a store app for installing various apps. The predetermined app is an app provided by the vendor of the communication apparatus 151. In the present embodiment, the predetermined app is an app for communicating with the communication apparatus 151 and making a connection setting of the communication apparatus 151. Hereinafter, the predetermined app is referred to as a "first app". The first app may have another function other than the function of making a connection setting of the communication apparatus 151. Specifically, for example, another function is the function of transmitting a print job for causing the communication apparatus 151 to execute printing (a print job transmission function), or the function of transmitting a scan job for causing the communication apparatus 151 to execute scanning (a scan job transmission function). To be exact, a process described as a process executed by the OS in the present embodiment is a process executed by the CPU 103 according to a program in the OS. Similarly, to be exact, a process described as a process executed by an app is a process executed by the CPU 103 according to a program in the app.

The RAM 105 is composed of a static random-access memory (SRAM), which requires a backup power supply, or the like. In the RAM 105, data is held by a primary battery for data backup (not illustrated). Thus, the RAM 105 can store important data such as a program control variable or the like without volatilizing the data. A memory area that stores setting information regarding the terminal apparatus 101, management data of the terminal apparatus 101, and the like is also provided in the RAM 105. The RAM 105 is also used as a main memory and a work memory for the CPU 103.

The external storage device 106 includes various programs such as a print information generation program for generating print information that can be interpreted by the communication apparatus 151, an information transmission/reception control program for transmitting and receiving information to and from the communication apparatus 151 connected to the terminal apparatus 101 via the wireless communication unit 109, and the like. The external storage device 106 also saves various pieces of information used by these programs and image data obtained from another information processing apparatus or the Internet.

The output interface 107 is an interface that controls the display unit 108 to display data or issue a notification of the state of the terminal apparatus 101.

The display unit 108 includes a light-emitting diode (LED), a liquid crystal display (LCD), or the like. The display unit 108 displays data or issues a notification of the state of the terminal apparatus 101. Alternatively, a software keyboard including keys such as a numerical input key, a mode setting key, a determination key, a cancellation key, a power key, and the like may be provided on the display unit 108, whereby an input from the user may be received through the display unit 108. In the present embodiment, the display unit 108 is a touch panel and can receive an operation using an operator such as a finger, a pen, or the like from the user.

The wireless communication unit 109 is a component for wirelessly connecting to an apparatus such as the communication apparatus 151, the AP 131, or the like and communicating data with the apparatus. For example, the wireless communication unit 109 may directly communicate with the communication apparatus 151 through wireless communication, or may communicate with the communication apparatus 151 via the AP 131 present outside the terminal apparatus 101 or the communication apparatus 151. Although in the present embodiment, Wi-Fi, which is a communication method based on the IEEE 802.11 standard, is used as the wireless communication method of the wireless communication unit 109, Bluetooth® Classic or the like may be used. In the present embodiment, a wireless LAN is a network using Wi-Fi. In the present embodiment, a connection using a method in which the terminal apparatus 101 and the communication apparatus 151 directly connect to each other not via an external AP is referred to as a "direct connection method". A connection using a method in which the terminal apparatus 101 and the communication apparatus 151 connect to each other via an external AP is referred to as an "infrastructure connection method".

The short-range wireless communication unit 110 is a component for communicating data with an apparatus such as the communication apparatus 151 or the like using a short-range wireless communication method and communicates using a communication method different from that of the wireless communication unit 109. The short-range wireless communication unit 110 can connect to a short-range wireless communication unit 157 in the communication apparatus 151. Examples of the communication method of the short-range wireless communication unit 110 include Bluetooth® Low Energy, Bluetooth® Classic, Wi-Fi Aware, NFC, and the like.

The imaging apparatus 111 is an apparatus that converts an image captured by an imaging element into digital data.

The digital data is temporarily stored in the RAM 105. Then, the digital data is converted into a predetermined image format by a program executed by the CPU 103 and is saved as image data in the external storage device 106.

The wired communication unit 112 is a component for connecting to an apparatus such as the communication apparatus 151, the AP 131, or the like by wire and communicating data with the apparatus. For example, the wired communication unit 112 communicates using the wired LAN. In the present embodiment, the wired LAN communicates based on the Ethernet standard. The present disclosure is not limited to this form, and for example, the wired communication unit 112 may communicate using a Universal Serial Bus (USB) cable. For example, in a case where the terminal apparatus 101 is a smartphone, the terminal apparatus 101 may not include the wired communication unit 112.

The communication apparatus 151 includes a ROM 152, a RAM 153, a CPU 154, a print engine 155, a wireless communication unit 156, a short-range wireless communication unit 157, an input interface 158, an output interface 159, a function control unit 160, a display unit 161, a wired communication unit 162, and the like.

The ROM 152, the RAM 153, the CPU 154, and the like form a computer of the communication apparatus 151.

The wireless communication unit 156 is a component for wirelessly connecting to an apparatus such as the terminal apparatus 101, the AP 131, or the like and communicating data with the apparatus. Although in the present embodiment, Wi-Fi based on the IEEE 802.11 standard is used as the wireless communication method of the wireless communication unit 156, Bluetooth® Classic or the like may be used. The wireless communication unit 156 includes, as an AP inside the communication apparatus 151, an AP 156-a for connecting to an apparatus such as the terminal apparatus 101 or the like. The AP 156-a can connect to the wireless communication unit 109 of the terminal apparatus 101. The wireless communication unit 156 may directly communicate with the terminal apparatus 101 via the AP 156-a, or may communicate with the terminal apparatus 101 via the AP 131. The AP 156-a may be hardware that functions as an AP, or the wireless communication unit 156 may operate as the AP 156-a by software for functioning as an AP. The communication apparatus 151 may be able to internally start a plurality of APs having different Service Set Identifiers (SSIDs) and passwords.

The RAM 153 is composed of a dynamic random-access memory (DRAM), which requires a backup power supply, or the like. In the RAM 153, data is held by supplying power for data backup (not illustrated) to the RAM 153. Thus, the RAM 153 can store important data such as a program control variable or the like without volatilizing the data. The RAM 153 is also used as a main memory and a work memory for the CPU 154. The RAM 153 saves a reception buffer for temporarily saving print information received from the terminal apparatus 101 or the like and also saves various pieces of information.

The ROM 152 stores fixed data such as control programs executed by the CPU 154, a data table, an OS program, and the like. In the present embodiment, the control programs stored in the ROM 152 control the execution of software such as scheduling, a task switch, an interrupt process, and the like under control of the embedded OS stored in the ROM 152. A memory area that stores data that needs to be held also in a case where power is not supplied, such as setting information regarding the communication apparatus 151, management data of the communication apparatus 151, and the like, is also provided in the ROM 152.

The CPU 154 is a system control unit and controls the entirety of the communication apparatus 151.

Based on information saved in the RAM 153, a print job received from the terminal apparatus 101, or the like, the print engine 155 forms an image on a recording medium such as paper or the like using a recording agent such as ink or the like and outputs the printing result. At this time, the amount of transmitted data of the print job transmitted from the terminal apparatus 101 or the like is large, and therefore, high-speed communication is required. Thus, the communication apparatus 151 receives the print job via the communication unit 156, which can communicate faster than the short-range wireless communication unit 157.

The short-range wireless communication unit 157 is a component for communicating with an apparatus such as the terminal apparatus 101 or the like using a short-range wireless communication method. Examples of the communication method of the short-range wireless communication unit 157 include Bluetooth® Low Energy, Bluetooth® Classic, Wi-Fi Aware, and the like.

The input interface 158 is an interface for receiving the input of data or an operation instruction from the user and is composed of a physical keyboard, a button, a touch panel, and the like. Alternatively, a form may be employed in which the output interface 159 and the input interface 158 are the same component, and the same component outputs a screen and receives an operation from the user. The output interface 159 is an interface that controls the display unit 161 to display data or issue a notification of the state of the communication apparatus 151.

The function control unit 160 manages a functional operation regarding whether to cause the functions of the communication apparatus 151 to simultaneously operate.

The display unit 161 includes an LED, an LCD, or the like. The display unit 161 displays data or issues a notification of the state of the communication apparatus 151. Alternatively, a software keyboard including keys such as a numerical input key, a mode setting key, a determination key, a cancellation key, a power key, and the like may be provided on the display unit 161, whereby an input from the user may be received through the display unit 161.

The wired communication unit 162 is a component for connecting to an apparatus such as the terminal apparatus 101, the AP 131, or the like by wire and communicating data with the apparatus. For example, the wired communication unit 162 communicates using the wired LAN. The present disclosure is not limited to this form, and for example, the wired communication unit 162 may communicate using a USB cable.

### Regarding Direct Connection Method

A "direct connection" refers to a form in which apparatuses wirelessly connect to each other directly (i.e., in a peer-to-peer manner) not via an external apparatus such as the AP 131 or the like. A direct connection is also referred to as a "peer-to-peer connection (P2P connection)". The communication apparatus 151 can operate in a mode for communicating through a direct connection (a direct connection mode) as one of connection modes. In Wi-Fi communication, there is a plurality of modes such as a software AP mode, a Wi-Fi Direct (WFD) mode, and the like as modes for communicating through a direct connection.

A mode for executing a direct connection using WFD is referred to as a "WFD mode". WFD is a standard formulated by the Wi-Fi Alliance and is a standard included in the communication standards of the IEEE 802.11 series. In the WFD mode, after a device as a communication partner is found by a search using a device search command, the roles of a P2P group owner (GO) and a P2P client are determined. Then, the remaining wireless connection process is performed. The group owner is equivalent to a Wi-Fi master station (master apparatus), and the client is equivalent to a Wi-Fi slave station (slave apparatus). For example, this role determination corresponds to GO negotiation in P2P. In the WFD mode in the state before the role determination is made, the communication apparatus 151 is neither a master station nor a slave station. Specifically, first, one device issues a device search command to a device with which to communicate, thereby searching for a device to which to connect in the WFD mode. If the other device as a communication partner is found by the search, both devices confirm information regarding services and functions that can be supplied by the other devices. This device supply information confirmation is an option and is not essential. For example, this device supply information confirmation phase corresponds to P2P provision discovery. Next, the devices confirm this device supply information with each other and determine which of the devices is to be a P2P client and which of the devices is to be a P2P group owner as their roles. Next, if the client and the group owner are determined, both devices exchange parameters for communicating using WFD with each other. Based on the exchanged parameters, the P2P client and the P2P group owner perform the remaining wireless connection process and an Internet Protocol (IP) connection process. In the WFD mode, the communication apparatus 151 may not execute the GO negotiation, and the communication apparatus 151 may always operate as a GO. That is, the communication apparatus 151 may operate in the WFD mode as autonomous GO mode. For example, the state where the communication apparatus 151 is operating in the WFD mode is the state where a connection using WFD is not established, but the communication apparatus 151 is operating as a GO, or the state where a connection using WFD is established, and the communication apparatus 151 is operating as a GO.

In the software AP mode, between devices (e.g., the terminal apparatus 101 and the communication apparatus 151) that communicate with each other, one device (e.g., the terminal apparatus 101) is a client that serves to request various services. Then, the other device achieves the function of an AP in Wi-Fi based on the settings of software. The software AP is equivalent to a Wi-Fi master station, and the client is equivalent to a Wi-Fi slave station. In the software AP mode, a client searches for a device as a software AP using a device search command. If a software AP is found by the search, the client and the software AP perform the remaining wireless connection process (the establishment of a wireless connection or the like) and then perform an IP connection process (the assignment of IP addresses or the like). As commands and parameters transmitted and received in a case where the client and the software AP achieve a wireless connection, those defined by the Wi-Fi standard may be used, and the commands and the parameters are not described here.

In the present embodiment, if the communication apparatus 151 establishes and maintains a direct connection, the communication apparatus 151 operates as a master station in a network to which the communication apparatus 151 belongs. The master station is an apparatus that constructs a wireless network and provides a parameter used to connect to the wireless network to a slave station. For example, the parameter used to connect to the wireless network is a parameter regarding a channel used by the master station. The slave station receives the parameter, thereby connecting to the wireless network constructed by the master station, using the channel used by the master station. In the direct connection mode, the communication apparatus 151 operates as the master station, and therefore, the communication apparatus 151 can determine which frequency band is to be used and which channel is to be used for communication in the direct connection mode. In the present embodiment, the communication apparatus 151 can use a channel corresponding to the 2.4 GHz frequency band and a channel corresponding to the 5 GHz frequency band for communication in the direct connection mode.

### Regarding Infrastructure Connection Method

An infrastructure connection is a connection form in which devices (e.g., the terminal apparatus 101 and the communication apparatus 151) that communicate with each other connect to an AP (e.g., the AP 131) that performs overall control of a network of the devices, and the devices communicate with each other via the AP. The communication apparatus 151 can also operate in a mode for communicating through an infrastructure connection (an infrastructure connection mode) as one of the connection modes.

In an infrastructure connection, each device searches for an AP using a device search command. If an AP is found by the search, the device and the AP perform the remaining wireless connection process (the establishment of a wireless connection or the like) and then perform an IP connection process (the assignment of IP addresses or the like). As commands and parameters transmitted and received in a case where the device and the AP achieve a wireless connection, those defined by the Wi-Fi standard may be used, and the commands and the parameters are not described here.

In the present embodiment, if the communication apparatus 151 operates through an infrastructure connection, the AP 131 operates as a master station, and the communication apparatus 151 operates as a slave station. That is, in the present embodiment, an "infrastructure connection" refers to a connection between the communication apparatus 151 operating as a slave station and an apparatus operating as a master station. If the communication apparatus 151 establishes an infrastructure connection with the AP 131, and the terminal apparatus 101 also establishes an infrastructure connection with the AP 131, the communication apparatus 151 and the terminal apparatus 101 can communicate with each other via the AP 131. A channel to be used for communication through the infrastructure connection is determined by the AP 131, and therefore, the communication apparatus 151 communicates through the infrastructure connection using the channel determined by the AP 131. In the present embodiment, the communication apparatus 151 can use a channel corresponding to the 2.4 GHz frequency band and a channel corresponding to the 5 GHz frequency band for communication through the infrastructure connection. The communication apparatus 151 can also use a channel corresponding to a Dynamic Frequency Selection (DFS) band in the 5 GHz frequency band for communication through the infrastructure connection. To communicate with the communication apparatus 151 via the AP 131, the terminal apparatus 101 recognizes and identifies that the communication apparatus 151 belongs to a network which is formed by the AP 131 and to which the terminal apparatus 101 belongs.

### Regarding Connection Setting Process

In the present embodiment, using wireless communication with the communication apparatus 151, the terminal apparatus 101 makes a connection setting (a network connection setting) for causing the communication apparatus 151 to operate in at least one of the infrastructure connection mode and the direct connection mode. The connection setting process in the present embodiment is executed through wireless communication and therefore is also termed "cableless setup (CLS)". Alternatively, the connection setting process may be executed through wired communication. When the first app stored in the external storage device 106 or the like is started, the terminal apparatus 101 performs the connection setting process on the communication apparatus 151. The communication apparatus 151 can operate in a connection setting mode (a connection setting state), which is a mode for executing the connection setting process. The communication apparatus 151 executes the connection setting process in the state where the communication apparatus 151 is operating in the connection setting mode. The details of the connection setting mode will be described below.

To cause the communication apparatus 151 to operate in the infrastructure connection mode, the terminal apparatus 101 wirelessly transmits infrastructure setting information as setting information for causing the communication apparatus 151 to operate in the infrastructure connection mode to the communication apparatus 151. The infrastructure setting information includes information regarding the AP 131. For example, the information regarding the AP 131 is the SSID, the password, information regarding the frequency band, and the like.

On the other hand, to cause the communication apparatus 151 to operate in the direct connection mode, the terminal apparatus 101 wirelessly transmits direct setting information as setting information for causing the communication apparatus 151 to operate in the direct connection mode to the communication apparatus 151. The direct setting information includes an instruction to enable a WFD function and cause the communication apparatus 151 to operate as a group owner, and an instruction to enable an access point setting of the communication apparatus 151. The terminal apparatus 101 acquires connection information required to make a direct connection to the communication apparatus 151 from the communication apparatus 151. The connection information for making a direct connection to the communication apparatus 151 includes information such as the SSID, the password, and the like of the communication apparatus 151 that operates in the direct connection mode.

In the present embodiment, to transmit the infrastructure setting information or the direct setting information or acquire the information for making a direct connection to the communication apparatus 151 in the connection setting process, a direct connection for the connection setting between the terminal apparatus 101 and the communication apparatus 151 is used. Then, in the present embodiment, as the direct connection for the connection setting, a connection using Wi-Fi is executed. However, for example, a wireless communication standard other than Wi-Fi, such as Bluetooth® or the like, may be used. Alternatively, as the direct connection for the connection setting, a wired communication standard such as the wired LAN, USB, or the like may be used.

After an infrastructure connection or a direct connection using Wi-Fi is established between the terminal apparatus 101 and the communication apparatus 151 by the connection setting process, the terminal apparatus 101 and the communication apparatus 151 can communicate with each other through the established connection. Specifically, for example, the terminal apparatus 101 can transmit a print job for causing the communication apparatus 151 to execute printing or a scan job for causing the communication apparatus 151 to execute scanning to the communication apparatus 151 through the established connection. Although in the present embodiment, it is possible to both cause the communication apparatus 151 to operate in the infrastructure connection mode and cause the communication apparatus 151 to operate in the direct connection mode by the connection setting process, the present disclosure is not limited to this form. For example, a form may be employed in which it is possible to only cause the communication apparatus 151 to operate in the infrastructure connection mode (i.e., it is not possible to cause the communication apparatus 151 to operate in the direct connection mode) by the connection setting process.

### Regarding Connection Setting Mode

The communication apparatus 151 can operate in a connection setting mode. For example, a trigger for the communication apparatus 151 to start operating in the connection setting mode may be the state where the user presses a button for the connection setting mode or the state where the communication apparatus 151 starts (is powered on) for the first time after the arrival of shipment. The button for the connection setting mode may be a hardware button included in the communication apparatus 151, or may be a software button displayed on the display unit 161 by the communication apparatus 151.

If the communication apparatus 151 starts operating in the connection setting mode, the communication apparatus 151 enables both Wi-Fi communication and Bluetooth® Low Energy communication. Specifically, as the process of enabling Wi-Fi communication, the communication apparatus 151 enables an AP dedicated to the connection setting mode and inside the communication apparatus 151 (a connection setting AP). Consequently, the communication apparatus 151 enters the state where the communication apparatus 151 can establish a direct connection using Wi-Fi with the terminal apparatus 101. Connection information (an SSID and a password) for connecting to the connection setting AP is held in advance in the first app installed on the terminal apparatus 101. That is, the terminal apparatus 101 recognizes in advance the connection information for connecting to the connection setting AP. Thus, unlike connection information regarding an AP that is enabled in the direct connection mode, the connection information for connecting to the connection setting AP cannot be optionally changed by the user. Alternatively, a form may be employed in which an encryption method is not set for the connection setting AP, and a password is not required to connect to the AP. In the connection setting mode, the communication apparatus 151 may connect to the terminal apparatus 101 using not normal Wi-Fi but WFD. That is, the communication apparatus 151 may operate as a group owner and receive a setting command from the terminal apparatus 101 through communication using WFD.

### Regarding Registration of Communication Apparatus in App

In the present embodiment, the first app acquires information regarding the communication apparatus 151 from the communication apparatus 151 and thereby can register the communication apparatus 151 in the first app.

For example, the information regarding the communication apparatus 151 is capability information regarding the communication apparatus 151, identification information (a media access control (MAC) address or the like) regarding the communication apparatus 151, model information regarding the communication apparatus 151, or the like. Specifically, the capability information regarding the communication apparatus 151 includes a list of information regarding functions with which the communication apparatus 151 is compatible, information regarding consumable products (ink and sheets) that can be used in the communication apparatus 151, information indicating the printing method of the communication apparatus 151, and the like. Then, the first app selects a single apparatus as a partner in communication by the first app among one or more communication apparatuses 151 registered in the first app. Hereinafter, the communication apparatus 151 currently selected as the apparatus as the partner in communication by the first app is referred to as the "communication apparatus 151 that is being selected". The selection of the apparatus as the partner in communication by the first app may be made by receiving from the user the selection of the apparatus from among the one or more communication apparatuses 151 registered in the first app, or may be automatically made according to a predetermined reference by the first app. For example, the apparatus as the partner in communication by the first app may be changed by receiving from the user the selection of the apparatus from among the one or more communication apparatuses 151 registered in the first app. In the present embodiment, the first app transmits various jobs such as a print job, a scan job, and the like to the communication apparatus 151 that is being selected. That is, the communication apparatus 151 that is being selected is an apparatus as the transmission destinations of the various jobs.

### Regarding First Issue Solved by Present Embodiment

To connect the communication apparatus 151 to an AP by the connection setting process, the terminal apparatus 101 transmits a password used to connect to the AP to the communication apparatus 151. Then, the communication apparatus 151 connects to the AP using the received password. There is a case where the password transmitted from the terminal apparatus 101 to the communication apparatus 151 in this process is a password input to the terminal apparatus 101 by the user. In this case, the user needs to recognize a correct password and input the correct password to the terminal apparatus 101. However, conventionally, there is a case where the user recognizes a wrong (incorrect) password, or even though the user recognizes a correct password, the user erroneously inputs the correct password, whereby a wrong password is input to the terminal apparatus 101. As a result, there is a case where the wrong password is transmitted to the communication apparatus 151, and the communication apparatus 151 cannot connect to the AP.

To solve such an issue, in the present embodiment, the terminal apparatus 101 executes a process for preventing a wrong password from being input to the terminal apparatus 101. Specifically, the first app of the terminal apparatus 101 displays a screen presenting a method for confirming a correct password on a screen displayed by a particular app of the terminal apparatus 101. The particular app is an app different from the predetermined app and installed in advance on the terminal apparatus 101 without being installed on the terminal apparatus 101 by the store app. The particular app is a setting app for making various settings of the terminal apparatus 101 and can make various settings including settings regarding a Wi-Fi connection of the terminal apparatus 101. Hereinafter, a screen for making settings regarding a Wi-Fi connection of the terminal apparatus 101 among various settings that can be made by a second app is referred to as a "Wi-Fi setting screen". Hereinafter, the particular app is referred to as a "second app". The second app can display a list of access points present near the terminal apparatus 101 on the Wi-Fi setting screen. If a password is required to connect to an access point selected from the list, the second app can receive the input of the password from the user on the Wi-Fi setting screen.

Then, if the connection using the password is successful, the second app saves and manages various pieces of information regarding the access point to which the terminal apparatus 101 is connected, using the password. Specifically, for example, the various pieces of information are information such as the password, the SSID, the security, and the like. That is, the second app has a management function for saving and managing information regarding an access point to which the terminal apparatus 101 is currently connected, and information regarding an access point to which the terminal apparatus 101 has been connected in the past. In the management function, the second app can display the password of the access point to which the terminal apparatus 101 is currently connected or the password of the access point to which the terminal apparatus 101 has been connected in the past on the Wi-Fi setting screen. The user confirms the password displayed by the second app and thereby can confirm the correct password of the access point. However, to display the password by the second app, several operations are required on a screen displayed by the second app. The terminal apparatus 101 includes the second app that differs depending on the OS or the model of the terminal apparatus 101, and therefore, there is a case where an operation for displaying the password by the second app differs depending on the OS or the model of the terminal apparatus 101. If the user does not correctly recognize the operation, the user cannot display the password by the second app. Thus, in the present embodiment, a screen presenting the operation for displaying the password by the second app is displayed.

If the OS of the terminal apparatus 101 is iPhone Operating System (iOS) (registered trademark) or iPadOS (registered trademark), there are a connection that is disconnected based on the transition of the first app to the background (hereinafter, a "first type of connection") and a connection that is not disconnected even if the first app transitions to the background (hereinafter, a "second type of connection") as a connection of the terminal apparatus 101 established according to an instruction from the first app. Specifically, the first type of connection is disconnected by the OS based on the lapse of a predetermined time (e.g., 15 seconds) with the first app remaining in the background after the transition. The second type of connection is maintained without being disconnected by the OS even if the predetermined time elapses with the first app remaining in the background after the transition. Then, as described above, in the present embodiment, the first app displays a screen prompting the user to confirm the password on the Wi-Fi setting screen displayed by the second app. If the user starts the second app according to the screen, the first app transitions to the background. Then, the following issue arises. In a case where a connection between the communication apparatus 151 operating in the connection setting mode and the terminal apparatus 101 is the first type of connection, and if the user starts the second app and confirms the password, the connection between the communication apparatus 151 operating in the connection setting mode and the terminal apparatus 101 is disconnected. Then, if the connection is disconnected, and even if the user confirms the password on the Wi-Fi setting screen displayed by the second app and inputs the password to the first app, the first app cannot transmit the input password to the communication apparatus 151. To transmit the input password to the communication apparatus 151, it is necessary to establish the connection again, but an operation for establishing the connection again is necessary, which is cumbersome to the user. Thus, in the present embodiment, control is performed so that a connection between the communication apparatus 151 operating in the connection setting mode and the terminal apparatus 101 is the second type of connection. Consequently, it is possible to perform control so that even if the first app transitions to the background by the user starting the second app, the connection is maintained without being disconnected.

As described above, the first app transmits setting information including the password input to the first app by the user to the communication apparatus 151, thereby establishing a connection between the communication apparatus 151 and an AP. However, there is a case where the user gives up a method in which the first app transmits the setting information to the communication apparatus 151 even though the first app displays a password input screen for a reason such as a failure in the confirmation of the password or the like. As the method for establishing a connection between the communication apparatus 151 and another apparatus, a method (another connection method) different from the method in which the first app transmits the setting information to the communication apparatus 151 also exists. However, there is an issue where if the user does not recognize the existence of another connection method or the details of another connection method, the user cannot establish a connection of the communication apparatus 151 by either the method in which the first app transmits the setting information to the communication apparatus 151 or another connection method. Thus, in the present embodiment, a button for displaying a manual regarding another connection method is displayed on the password input screen. Consequently, it is possible to guide the user who gives up the method in which the first app transmits the setting information to the communication apparatus 151 even though the first app displays the password input screen, through another connection method. Thus, it is possible to improve usability.

The present disclosure may not need to solve all the above issues, and may only need to solve any of the above issues. In other words, not all the processes for solving the above issues may need to be executed, and any of the processes for solving the above issues may only need to be executed.

### Regarding Processing Executed by First App in Present Embodiment

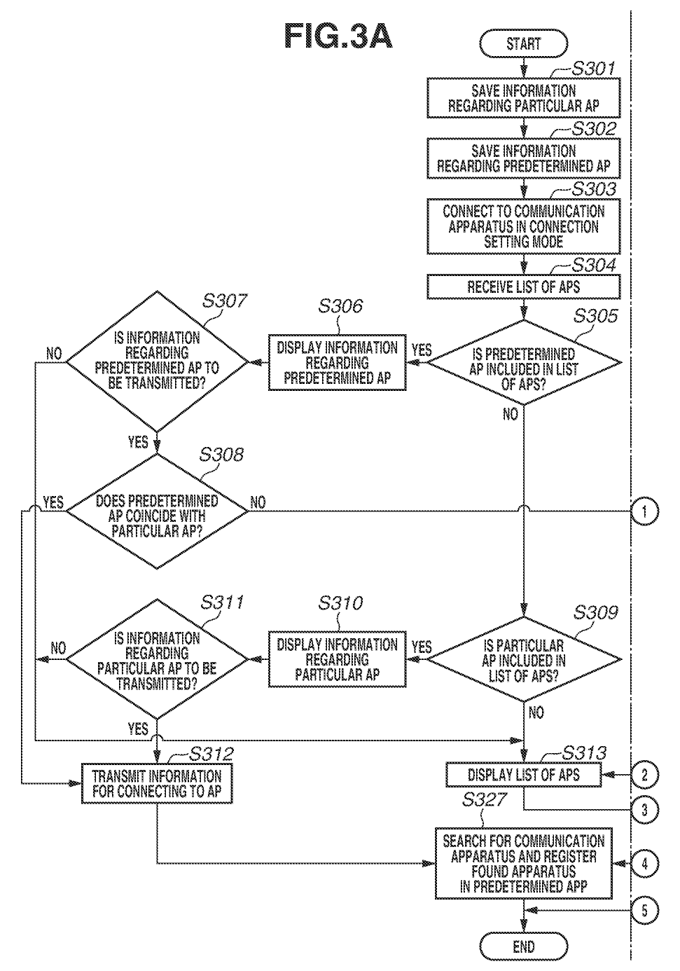

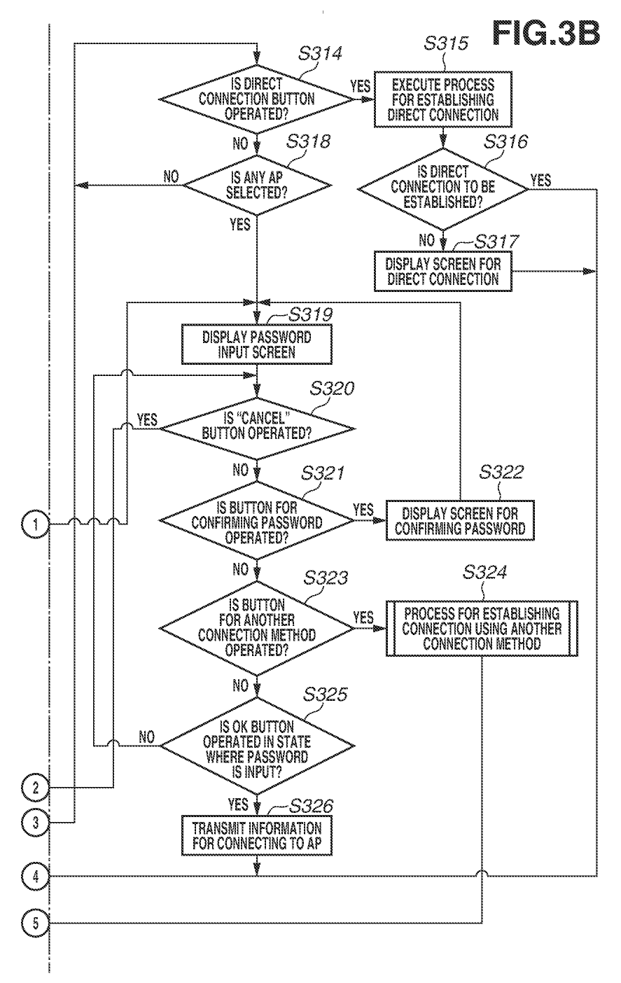

FIGS. 3A and 3B are a flowchart illustrating an example of processing executed using the first app by the terminal apparatus 101 in the present embodiment. Processes in the flowchart in FIGS. 3A and 3B are achieved by, for example, the CPU 103 loading the first app stored in a memory such as the ROM 104 or the like into the RAM 105 and executing the first app. The flowchart in FIGS. 3A and 3B is started based on the execution of an operation for executing the connection setting process on a screen displayed by the first app. Alternatively, the flowchart in FIGS. 3A and 3B may be started according to the start of the first app.

In step S301, the first app acquires, from a communication apparatus 151 that is being selected, information regarding an AP to which the communication apparatus 151 that is being selected is currently connected using Wi-Fi. Then, the first app saves the information. Hereinafter, the AP to which the communication apparatus 151 that is being selected is currently connected using Wi-Fi is referred to as a "particular AP". The information regarding the particular AP acquired in this step includes the SSID and the password. For example, the information regarding the particular AP is acquired through an infrastructure connection or a direct connection between the terminal apparatus 101 and the communication apparatus 151. If the terminal apparatus 101 cannot currently communicate with the communication apparatus 151 that is being selected, or if the communication apparatus 151 that is being selected is not currently connected to an AP using Wi-Fi, the information regarding the particular AP is not acquired. The timing when the information regarding the particular AP is acquired is not limited to this timing. For example, based on the start of the first app, the information regarding the particular AP may be acquired at a timing before the flowchart in FIGS. 3A and 3B is started. In this form, the process of step S301 is skipped.

In step S302, the first app acquires, from the OS, information regarding an AP to which the terminal apparatus 101 is currently connected using Wi-Fi. Then, the first app saves the information. In other words, the AP to which the terminal apparatus 101 is currently connected using Wi-Fi is an AP to which the terminal apparatus 101 is connected when a process as a trigger for the start of the flowchart in FIGS. 3A and 3B is executed. The process as the trigger for the start of the flowchart in FIGS. 3A and 3B is the reception of the operation for executing the connection setting process or the start of the first app. Hereinafter, the AP to which the terminal apparatus 101 is connected using Wi-Fi at the timing of step S301 is referred to as a "predetermined AP". The information regarding the AP acquired in this step is information that can be acquired from the OS by the first app among various pieces of information regarding the AP, and specifically, for example, is the SSID. If the terminal apparatus 101 is not currently connected to an AP using Wi-Fi, the information regarding the predetermined AP is not acquired.

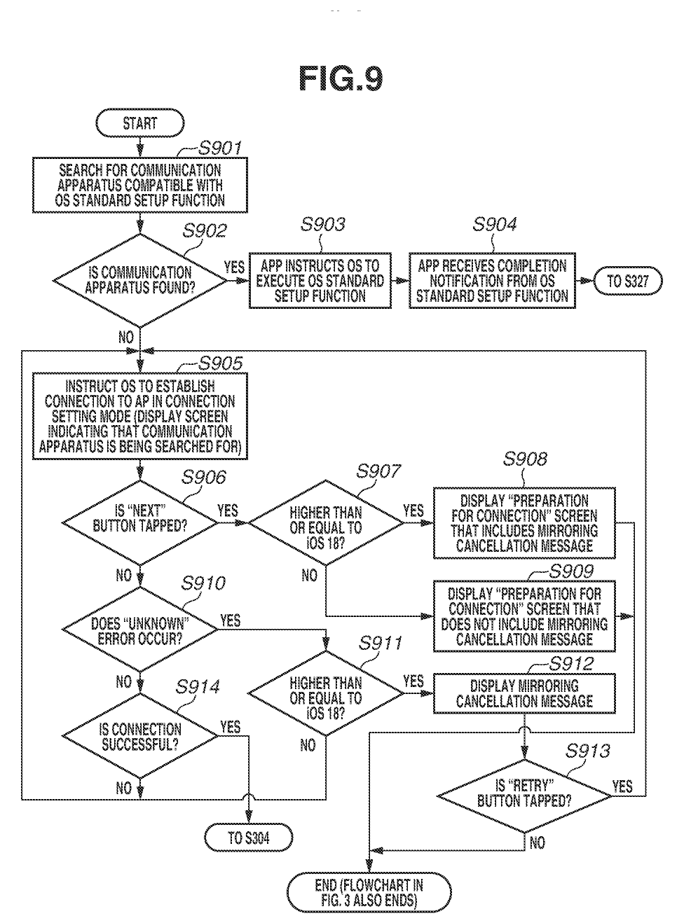

In step S303, the first app executes a process for establishing a connection between the communication apparatus 151 operating in the connection setting mode and the terminal apparatus 101. Specifically, the first app instructs the OS to establish a connection between the communication apparatus 151 operating in the connection setting mode and the terminal apparatus 101. More specifically, the first app executes a predetermined application programming interface (API) for establishing a connection of the terminal apparatus 101 while setting at least a partial character string of the SSID of the communication apparatus 151 operating in the connection setting mode as an argument. As a result, the OS searches for an apparatus having an SSID including the character string and establishes a connection between a found apparatus (i.e., the communication apparatus 151 operating in the connection setting mode) and the terminal apparatus 101. The communication apparatus 151 to which the terminal apparatus 101 connects by this process is a communication apparatus 151 found first by the search executed in the process of step S303. The present disclosure, however, is not limited to this form. The first app may display a plurality of communication apparatuses 151 found by the search executed in the process of step S303 and receive the selection of any of the displayed plurality of communication apparatuses 151 from the user. Then, the communication apparatus 151 to which the terminal apparatus 101 connects by this process may be the communication apparatus 151 selected by the user. While the connection between the communication apparatus 151 operating in the connection setting mode and the terminal apparatus 101 is established, communication between the communication apparatus 151 and the terminal apparatus 101 is executed through this connection. The details of the process of step S303 will be described below with reference to FIG. 9.

In the present embodiment, the first app for iOS performs control so that the connection between the communication apparatus 151 operating in the connection setting mode and the terminal apparatus 101 is the second type of connection. Specifically, in step S303, the first app for iOS executes a predetermined API while setting a flag for instructing the OS to establish the second type of connection. Consequently, the OS establishes the connection between the communication apparatus 151 operating in the connection setting mode and the terminal apparatus 101 as the second type of connection. Consequently, even if a predetermined time elapses after the first app operates in the background, the connection between the communication apparatus 151 operating in the connection setting mode and the terminal apparatus 101 is not disconnected.

In step S304, the first app acquires, from the communication apparatus 151, information regarding a list of APs found by a search executed by the communication apparatus 151. The APs found by the search executed by the communication apparatus 151 are APs to which the communication apparatus 151 can connect. The APs to which the communication apparatus 151 can connect are APs located in the range where the communication apparatus 151 can communicate, and are APs compatible with the capability of the communication apparatus 151. For example, if the communication apparatus 151 can communicate in the 2.4 GHz band, but cannot communicate in the 5 GHz band, the list of APs indicated by the acquired information includes APs compatible with communication in the 2.4 GHz band, but does not include APs compatible with communication in the 5 GHz band.

In step S305, the first app determines whether the AP indicated by the information saved in step S302 (the predetermined AP) is included in the list of APs indicated by the information acquired in step S304. If the determination is YES (YES in step S305), the processing proceeds to step S306. If the determination is NO (NO in step S305), the processing proceeds to step S309.

In step S306, the first app displays the information regarding the predetermined AP and displays a confirmation screen for confirming with the user whether to set a connection target of the communication apparatus 151 to the predetermined AP. The information displayed in this step is the information saved in step S302, and for example, is the SSID of the predetermined AP.

In step S307, the first app determines whether to transmit the information regarding the predetermined AP to the communication apparatus 151. In other words, this determination is the determination of whether the user confirms that the connection target of the communication apparatus 151 is set to the predetermined AP. Thus, if an input indicating that the connection target of the communication apparatus 151 is set to the predetermined AP is provided on the confirmation screen, the determination is YES, and the predetermined AP is identified as the connection target of the communication apparatus 151. Then, if an input indicating that the connection target of the communication apparatus 151 is not set to the predetermined AP is provided on the confirmation screen, the determination is NO. If the determination is YES (YES in step S307), the processing proceeds to step S308. If the determination is NO (NO in step S307), the processing proceeds to step S313.

In step S308, the first app determines whether the predetermined AP coincides with the particular AP. If the predetermined AP coincides with the particular AP, this means that the first app holds the password of the predetermined AP. Thus, this determination is the determination of whether the first app holds the password of the predetermined AP. In other words, this determination is the determination of whether the password of the predetermined AP is held in a storage area to which the first app can refer. If the determination is YES (YES in step S308), the processing proceeds to step S312. In step S312, the first app transmits the information regarding the predetermined AP to the communication apparatus 151. If the determination is NO (NO in step S308), the processing proceeds to step S319. In step S319, the first app displays a password input screen.

Alternatively, in step S308, it may not be determined whether the predetermined AP coincides with the particular AP. The determination made in step S308 may be the process of determining whether the predetermined AP is an AP corresponding to information held in the storage area to which the first app can refer.

For example, a case where the determination is YES in this form is a case where the password for connecting to the predetermined AP has been input to the first app by the user and transmitted to the communication apparatus 151 in the connection setting process executed in the past by the first app. For example, a case where the determination is NO in this form is a case where the password for connecting to the predetermined AP has not been input to the first app by the user in the connection setting process executed in the past by the first app.

In step S309 executed if the determination result in step S305 is NO, the first app determines whether the AP indicated by the information saved in step S301 (the particular AP) is included in the list of APs indicated by the information acquired in step S304. If the determination is YES (YES in step S309), the processing proceeds to step S310. If the determination is NO (NO in step S309), the processing proceeds to step S313.

In step S310, the first app displays the information regarding the particular AP and displays a confirmation screen for confirming with the user whether to set the connection target of the communication apparatus 151 to the particular AP. The information displayed in this step is the information saved in step S301, and for example, is the SSID of the particular AP.

In step S311, the first app determines whether to transmit the information regarding the particular AP to the communication apparatus 151. In other words, this determination is the determination of whether the user confirms that the connection target of the communication apparatus 151 is set to the particular AP. Thus, if an input indicating that the connection target of the communication apparatus 151 is set to the particular AP is provided on the confirmation screen, the determination is YES, and the particular AP is identified as the connection target of the communication apparatus 151. Then, if an input indicating that the connection target of the communication apparatus 151 is not set to the particular AP is provided on the confirmation screen, the determination is NO. If the determination is YES (YES in step S311), the processing proceeds to step S312. If the determination is NO (NO in step S311), the processing proceeds to step S313.

In step S312, the first app transmits information for connecting to the AP identified as the connection target of the communication apparatus 151 to the communication apparatus 151. The information transmitted in this step includes the SSID of the AP identified as the connection target of the communication apparatus 151 and the password for connecting to the AP identified as the connection target of the communication apparatus 151. In this process, the AP identified as the connection target of the communication apparatus 151 is the predetermined AP that coincides with the particular AP, or the particular AP. That is, the password transmitted in this step is the password of the particular AP and is the password acquired from the communication apparatus 151 in step S301. In other words, the password transmitted in this step is the password held in the first app (the password held in the storage area to which the first app can refer). Thus, after the connection target of the communication apparatus 151 is identified, the first app transmits the password to the communication apparatus 151 without receiving the input of the password from the user. After the information for connecting to the AP identified as the connection target of the communication apparatus 151 is transmitted to the communication apparatus 151, the communication apparatus 151 ends the connection setting mode and connects to the AP identified as the connection target of the communication apparatus 151 using the received information. The connection setting mode is ended, whereby the connection between the communication apparatus 151 and the terminal apparatus 101 is also disconnected. By a reconnection function of the OS, the terminal apparatus 101 connects again to the predetermined AP that is the AP to which the terminal apparatus 101 has been connected before the terminal apparatus 101 has connected to the communication apparatus 151. Then, the processing proceeds to step S327. The present disclosure is not limited to the form in which the processing proceeds to step S327. A form may be employed in which the processing proceeds to the process of displaying a screen for searching for a communication apparatus 151 on a Wi-Fi network to which the terminal apparatus 101 is connected as illustrated in step S710 described below.

If the determination result in step S307 is NO, or if the determination result in step S309 is NO, or if the determination result in step S311 is NO, step S313 is executed. Then, in step S313, the first app displays the list of APs indicated by the information acquired in step S304. In the present embodiment, a screen including the list includes a direct connection button. If the list does not include an AP desired as the connection target of the communication apparatus 151 by the user, the user operates the direct connection button.

In step S314, the first app determines whether the direct connection button is operated. If the determination is YES (YES in step S314), the processing proceeds to step S315. If the determination is NO (NO in step S314), the processing proceeds to step S318.

In step S315, the first app executes a process for establishing a direct connection between the communication apparatus 151 and the terminal apparatus 101. Specifically, first, the first app transmits direct setting information to the communication apparatus 151. Then, the first app acquires connection information for making a direct connection to the communication apparatus 151 from the communication apparatus 151. Then, the first app instructs the OS to establish a connection between the communication apparatus 151 operating in the direct connection mode and the terminal apparatus 101. More specifically, the first app identifies the SSID of the communication apparatus 151 operating in the direct connection mode from the received connection information. Then, the first app executes a predetermined API for establishing a connection of terminal apparatus 101 while setting at least a partial character string of the identified SSID as an argument. As a result, the OS searches for an apparatus having an SSID including the character string and displays a confirmation screen for confirming whether to establish a direct connection between a found apparatus (the communication apparatus 151 operating in the direct connection mode) and the terminal apparatus 101. If the first app is an app for iOS, then in this process, the first app may execute a predetermined API while setting a flag for instructing the OS to establish a connection that is not disconnected even if the first app transitions to the background. That is, the direct connection between the communication apparatus 151 and the terminal apparatus 101 may be established as the second type of connection. The present disclosure, however, is not limited to this form. In this process, the first app may execute a predetermined API without setting the flag, and the direct connection between the communication apparatus 151 and the terminal apparatus 101 may be established as the first type of connection.

In step S316, the first app determines whether a user operation indicating that the direct connection is to be established is performed on the confirmation screen displayed by the OS in step S315. This determination is made by the first app receiving from the OS a notification indicating which operation is performed on the confirmation screen displayed by the OS. If a user operation indicating that the direct connection is to be established is performed, the OS establishes the direct connection. If, however, a user operation indicating that the direct connection is not to be established is performed, the OS does not establish the direct connection. If the determination is YES (YES in step S316), the processing proceeds to step S327. If the determination is NO (NO in step S316), the processing proceeds to step S317.

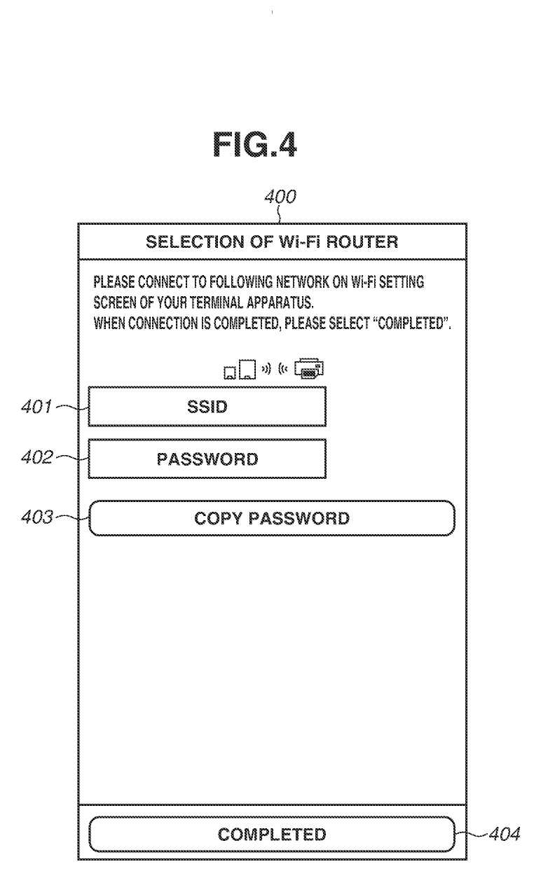

In step S317, the first app displays a screen for the direct connection. FIG. 4 illustrates an example of the screen displayed in this process. A screen 400 includes an SSID display area 401, a password display area 402, an area 403 for copying the password, and a "completed" button 404. The SSID display area 401 is an area that displays the SSID of the communication apparatus 151 operating in the direct connection mode. The password display area 402 is an area that displays the password of the communication apparatus 151 operating in the direct connection mode. If the area 403 is operated, the first app copies the password of the communication apparatus 151 operating in the direct connection mode and saves the password in a clipboard of the terminal apparatus 101. The password of the communication apparatus 151 operating in the direct connection mode is copied, whereby the user can easily input the password in the second app and can establish the direct connection by the second app. The screen 400 may include a message prompting the user to establish the direct connection through the Wi-Fi setting screen displayed by the second app, or a message prompting the user to operate the "completed" button 404 if the establishment of the direct connection is completed. If the "completed" button 404 is operated, the processing proceeds to step S327. The present disclosure is not limited to the form in which the processing proceeds to step S327. A form may be employed in which the processing proceeds to the process of displaying a screen for searching for a communication apparatus 151 on a Wi-Fi network to which the terminal apparatus 101 is connected as illustrated in step S710 described below.

In step S318 executed if the determination result in step S314 is NO, the first app determines whether any AP is selected from the displayed list of APs by the user. If the determination is YES (YES in step S318), the first app identifies the selected AP as the connection target of the communication apparatus 151, and the processing proceeds to step S319. If the determination is NO (NO in step S318), the processing returns to step S314. In step S314, the first app waits to receive any operation.

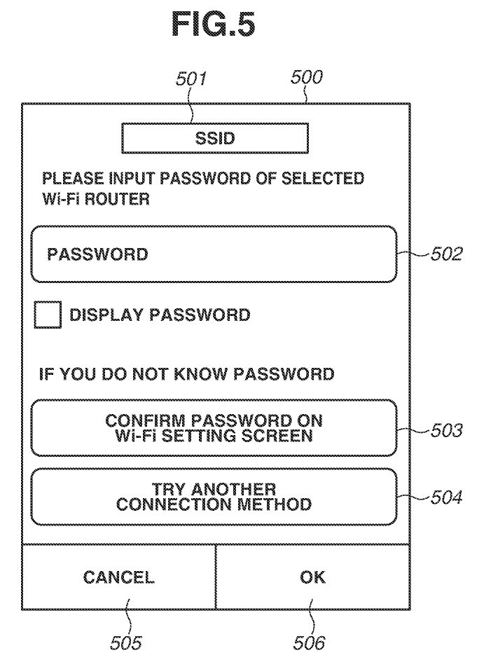

In step S319, the first app displays a password input screen for receiving the input of the password for connecting to the AP identified as the connection target of the communication apparatus 151 (first display control). The password input screen may be displayed in a pop-up manner on top of the list of APs. FIG. 5 illustrates an example of the screen displayed in this process. A password input screen 500 includes an SSID display area 501, a password input box 502 (a first area), a button 503 for confirming the password, a button 504 for another connection method, an "OK" button 506, and a "cancel" button 505. The SSID display area 501 is an area that displays the SSID of the AP identified as the connection target of the communication apparatus 151. The password input box 502 is an area that receives the input of the password of the AP identified as the connection target of the communication apparatus 151 from the user. The button 503 for confirming the password is a button regarding the function of displaying the password on the Wi-Fi setting screen by the second app. The button 504 for another connection method is a button for displaying a manual regarding another connection method. In the present embodiment, "another connection method" refers to a connection method other than a method for establishing a connection between the communication apparatus 151 and another apparatus by the first app transmitting setting information to the communication apparatus 151. In other words, another connection method is a method for establishing a connection between the communication apparatus 151 and another apparatus without the first app transmitting setting information to the communication apparatus 151.

Depending on the version of the OS of the terminal apparatus 101, there is a case where the second app cannot display on the Wi-Fi setting screen the password of an access point to which the terminal apparatus 101 is currently connected and the password of an access point to which the terminal apparatus 101 has been connected in the past. Specifically, for example, if the OS of the terminal apparatus 101 is a version lower than iOS 16 or a version lower than iPadOS 16, the second app cannot display the above passwords on the Wi-Fi setting screen. Thus, in step S319, the first app may identify the version of the OS of the terminal apparatus 101 and determine whether the identified version is a version that does not allow the second app to display the above passwords on the Wi-Fi setting screen. Then, if the result of the determination is YES, the first app may display the password input screen that does not include the button 503 for confirming the password. If the result of the determination is NO, the first app may display the password input screen that includes the button 503 for confirming the password. The password input screen that does not include the button 503 for confirming the password includes other buttons and areas on the screen 500. That is, the button 504 for another connection method is displayed regardless of the version of the OS. For example, in a case where the first app is only compatible with a version of the OS that allows the second app to display the above passwords on the Wi-Fi setting screen, or the like, the determination of the version and the control for switching the display screen based on the result of the determination of the version may not be executed.

In step S320, the first app determines whether a user operation on the "cancel" button 505 is received. If the determination is YES (YES in step S320), the processing proceeds to step S313. In step S313, the first app displays the list of APs. If the determination is NO (NO in step S320), the processing proceeds to step S321.

In step S321, the first app determines whether a user operation on the button 503 for confirming the password is received. If the determination is YES (YES in step S321), the processing proceeds to step S322. If the determination is NO (NO in step S321), the processing proceeds to step S323.

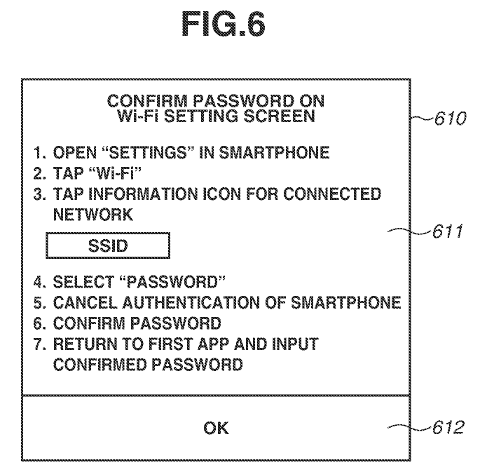

In step S322, the first app displays a screen for confirming the password. In the present embodiment, the screen for confirming the password is a predetermined screen indicating a method for confirming the password of the AP on the Wi-Fi setting screen displayed by the second app. FIG. 6 illustrates an example of the screen displayed in this process. In the present embodiment, the screen for confirming the password is not a web page displayed through Internet communication by a web browser. That is, the screen for confirming the password is a screen displayed on the first app based on information held in advance in the first app. For example, the web browser is an internal browser included in the first app or a browser included in a browser app different from the first app.

The present disclosure, however, is not limited to this form. The screen for confirming the password may be a web page displayed by the web browser. The screen for confirming the password may be displayed in a pop-up manner on top of the list of APs.

FIG. 6 illustrates the screen for confirming the password that is displayed in a case where the OS of the terminal apparatus 101 is iOS or iPadOS and the first app is an app for iOS or an app for iPadOS. A screen 610 includes an area 611 indicating a method for confirming the password of the AP on the Wi-Fi setting screen displayed by the second app compatible with iOS or iPadOS (hereinafter, a "second password confirmation method"), and an "OK" button 612. The area 611 displays text indicating an operation for confirming the password on the Wi-Fi setting screen compatible with iOS or iPadOS as text indicating the second password confirmation method. The screen 610 may display the SSID of the AP identified as the connection target of the communication apparatus 151. The area 611 may display text prompting the user to return to the first app (cause the first app to transition to the foreground again) after confirming the password. The user who has confirmed the text starts the second app through a home screen of the terminal apparatus 101 or the like and executes the operation indicated by the text, thereby confirming the password. Then, after confirming the password, the user causes the first app to operate in the foreground again, operates the "OK" button 612, and inputs the password on the first app. All terminal apparatuses with iOS higher than or equal to a predetermined version or iPadOS higher than or equal to a predetermined version have a function for confirming the password on the Wi-Fi setting screen.

Thus, the screen 610 does not include a button for another connection method. The present disclosure, however, is not limited to this form. The screen 610 may also include a button for another connection method. A terminal apparatus with iOS or iPadOS cannot start the second app according to an instruction from the first app. Thus, the screen 610 does not include a button for displaying the Wi-Fi setting screen. The present disclosure, however, is not limited to this form. If a terminal apparatus with iOS or iPadOS can start the second app according to an instruction from the first app, the screen 610 may include a button for displaying the Wi-Fi setting screen. If the "OK" button 612 is operated, the processing proceeds to step S319. Although in the present embodiment, text indicating a first password confirmation method and the text indicating the second password confirmation method are different from each other, the present disclosure is not limited to this form. The text indicating the first password confirmation method and the text indicating the second password confirmation method may be identical to each other.

In step S323 executed if the determination result in step S321 is NO, the first app determines whether a user operation on the button 504 for another connection method is received. If the determination is YES (YES in step S323), the processing proceeds to step S324. If the determination is NO (NO in step S323), the processing proceeds to step S325. The details of the process of step S324 will be described below.

In step S325, the first app determines whether a user operation on the "OK" button 506 is received in the state where the password is input to the password input box 502. Since the user operates the button 503 for confirming the password, the user can input the password to the password input box 502 after confirming the password on the Wi-Fi setting screen according to the text displayed on the screen illustrated in FIG. 6. If the password is copied on the Wi-Fi setting screen and saved in the clipboard, the user can input the password by pasting the saved password to the password input box 502. If the determination is YES (YES in step S325), the processing proceeds to step S326. If the determination is NO (NO in step S325), the processing returns to step S320. In step S320, the first app waits to receive any operation on the password input screen 500 from the user.

In step S326, the first app transmits information for connecting to the AP identified as the connection target of the communication apparatus 151 to the communication apparatus 151. Specifically, the information transmitted in this step includes the password input to the password input box 502 and the SSID of the AP identified as the connection target of the communication apparatus 151. After the information for connecting to the AP identified as the connection target of the communication apparatus 151 is transmitted to the communication apparatus 151, the communication apparatus 151 ends the connection setting mode and connects to the AP identified as the connection target of the communication apparatus 151 using the received information. The connection setting mode is ended, whereby the connection between the communication apparatus 151 and the terminal apparatus 101 is also disconnected. By the reconnection function of the OS, the terminal apparatus 101 connects again to the predetermined AP that is the AP to which the terminal apparatus 101 has been connected before the terminal apparatus 101 has connected to the communication apparatus 151. Then, the processing proceeds to step S327.

In step S327, the first app searches for a communication apparatus 151 on a Wi-Fi network to which the terminal apparatus 101 is connected. For example, if the AP identified as the connection target of the communication apparatus 151 is the predetermined AP, both the communication apparatus 151 and the terminal apparatus 101 connect to the predetermined AP, and therefore, a communication apparatus 151 is found by this search. If the AP identified as the connection target of the communication apparatus 151 is an AP other than the predetermined AP and the communication apparatus 151 connects to the AP other than the predetermined AP, or if the communication apparatus 151 fails in connecting to the AP because the input password is wrong, a communication apparatus 151 is not found by this search. If a communication apparatus 151 is found by this search, information regarding the communication apparatus 151 is acquired from the communication apparatus 151 via the Wi-Fi network to which the terminal apparatus 101 is connected, and the communication apparatus 151 is registered in the first app. At this time, the first app may automatically set the newly registered communication apparatus 151 as a communication apparatus 151 that is being selected. Then, the first app ends the processing and displays a home screen of the first app.

### Regarding Second Issue Solved by Present Embodiment

For example, in FIG. 1, the terminal apparatus 101 is a smartphone (e.g., iPhone (registered trademark)), the terminal apparatus 121 is a personal computer (e.g., Mac), and the communication apparatus 151 is a printer. The terminal apparatus 101 can wirelessly communicate with the terminal apparatus 121. The terminal apparatus 101 has the iOS 18 operating system, and the terminal apparatus 121 has the macOS (registered trademark) Sequoia operating system. This combination of the operating systems can achieve a mirroring function. Specifically, for example, the mirroring function is a function termed iPhone Mirroring. The mirroring function is a function in which the terminal apparatus 101 transfers (transmits) screen information to the terminal apparatus 121 and causes the terminal apparatus 121 to display a screen corresponding to the screen information, and the terminal apparatus 101 can be operated by operating the screen on the terminal apparatus 121. The mirroring function is started by the execution of an operation for starting the mirroring function on a screen displayed by an app for executing the mirroring function (hereinafter, a "mirroring function app") included in the terminal apparatus 121. The mirroring function is started under the condition that the terminal apparatus 101 is in a locked state. The mirroring function is cancelled by the execution of an operation for cancelling (disabling) the mirroring function on the screen displayed by the mirroring function app. The mirroring function is also cancelled by releasing the locked state of the terminal apparatus 101 by performing an operation for releasing the locked state of the terminal apparatus 101. While the mirroring function is being executed, the terminal apparatus 101 can perform a process based on an operation on the terminal apparatus 121. That is, every time an operation is executed on the terminal apparatus 121, the terminal apparatus 121 appropriately transmits information indicating the executed operation to the terminal apparatus 101. Consequently, the terminal apparatus 101 considers that the operation indicated by the received information is performed on the terminal apparatus 101. Then, the terminal apparatus 101 executes on the terminal apparatus 101 the same process as a process to be executed in a case where the operation is performed on the terminal apparatus 101. While the terminal apparatus 101 is causing the terminal apparatus 121 to display the screen using the mirroring function, the terminal apparatus 101 is in the locked state, and therefore, the display unit 108 of the terminal apparatus 101 is turned off and enters the state where nothing is displayed. The present disclosure, however, is not limited to this form. The terminal apparatus 101 may enter the state where a screen indicating that the mirroring function is being executed is displayed. Thus, it can be said that the mirroring function is the function of displaying a screen for controlling the terminal apparatus 101 on a display unit of the terminal apparatus 121 instead of the display unit 108 of the terminal apparatus 101. If the mirroring function is cancelled, the screen displayed on the display unit of the terminal apparatus 121 by the mirroring function is displayed on the display unit 108 of the terminal apparatus 101. The present disclosure, however, is not limited to this form. While the mirroring function is being executed, the screen displayed on the display unit of the terminal apparatus 121 may be displayed also on the display unit 108 of the terminal apparatus 101. That is, the mirroring function may be the function of displaying a screen displayed on the display unit 108 of the terminal apparatus 101 also on the display unit of the terminal apparatus 121.

However, while the mirroring function is being executed, even if the first app on the terminal apparatus 101 instructs the OS to connect to the AP enabled by the communication apparatus 151 operating in the connection setting mode in step S303 in FIG. 3A, the connection fails.

Specifically, the OS notifies the first app of an "unknown" error. Also in a case where an AP as a connection target is not present near the terminal apparatus 101, the first app is notified of the "unknown" error. Thus, it is considered that while the mirroring function is being executed, an AP search fails, and therefore, the first app is notified of the "unknown" error. Accordingly, with reference to FIG. 9, a method for solving this issue is described.

### Regarding Processing for Solving Second Issue

FIG. 9 is a flowchart illustrating the details of an example of the connection process in the connection setting mode in step S303 in FIG. 3A. Processes in the flowchart in FIG. 9 are achieved by, for example, the CPU 103 loading the first app stored in a memory such as the ROM 104 or the like into the RAM 105 and executing the first app.

The terminal apparatus 101 can execute the mirroring function on the terminal apparatus 121. A control method for controlling the terminal apparatus 101 is described below.

In step S901, the first app instructs the OS to search for a communication apparatus 151 compatible with an OS standard setup function.

In step S902, the first app receives the result of the search from the OS, and based on the result of the search, determines whether a communication apparatus 151 compatible with the OS standard setup function is found. If it is determined that a communication apparatus 151 is found (YES in step S902), the processing proceeds to step S903. If it is determined that a communication apparatus 151 is not found (NO in step S902), the processing proceeds to step S905.

In step S903, the first app instructs the OS to execute the OS standard setup function. In step S903, the process of step S905 is not performed.

In step S904, the first app receives a completion notification from the OS standard setup function, and the processing proceeds to step S327 in FIG. 3A.

In step S905, the first app transmits an instruction to establish a connection between a predetermined AP enabled by the communication apparatus 151 operating in the connection setting mode and the terminal apparatus 101 to the OS. More specifically, the first app executes a predetermined API for establishing a connection of the terminal apparatus 101 while setting at least a partial character string of the SSID of the communication apparatus 151 operating in the connection setting mode as an argument. As a result, the OS searches for an apparatus having an SSID including the character string.

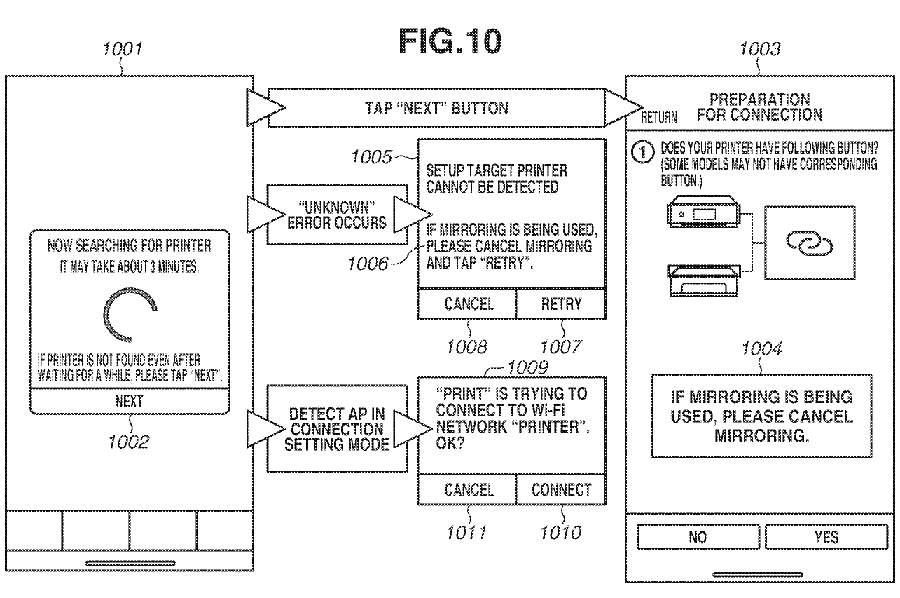

The first app displays a screen 1001 indicating that a communication apparatus 151 is being searched for in FIG. 10. The screen 1001 is a screen displayed while the first app is waiting to receive the result of the instruction to establish the connection in step S905 from the OS, and includes a "next" button 1002. The "next" button 1002 is a button that is tapped in a case where a communication apparatus 151 is not found even after the first app waits for a while.

In step S906, the first app determines whether the "next" button 1002 is tapped. The tap on the "next" button 1002 is an example of a predetermined operation performed on the screen 1001. If it is determined that the "next" button 1002 is tapped (YES in step S906), the processing proceeds to step S907. If it is determined that the "next" button 1002 is not tapped (NO in step S906), the processing proceeds to step S910.

In step S907, the first app determines whether the version of the OS is a version higher than or equal to iOS 18. If the version of the OS is a version higher than or equal to iOS 18, the mirroring function is implemented. If the version of the OS is a version lower than iOS 18, the mirroring function is not implemented. iOS 18 is an example of a predetermined version. If it is determined that the version of the OS is a version higher than or equal to iOS 18 (YES in step S907), the processing proceeds to step S908. If it is determined that the version of the OS is a version lower than iOS 18 (NO in step S907), the processing proceeds to step S909.

In step S908, the first app displays a "preparation for connection" screen 1003 that includes a mirroring cancellation message 1004 in FIG. 10. Then, the first app processes the "preparation for connection" screen 1003, and the processing returns to step S905. The mirroring cancellation message 1004 is an example of a message prompting the user to disable (cancel) the mirroring function. The "preparation for connection" screen 1003 is also a screen for disabling the mirroring function.

If the terminal apparatus 101 is executing the mirroring function, there is a high possibility that the connection based on the connection instruction in step S905 fails. If the user disables the mirroring function of the terminal apparatus 101 according to the mirroring cancellation message 1004, there is a high possibility that a connection is successful based on a connection instruction in subsequent step S905.

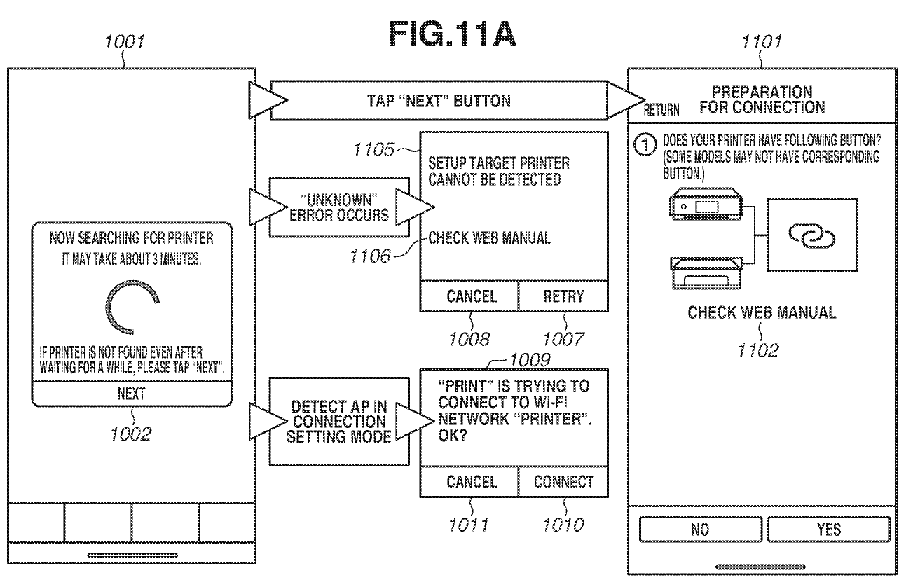

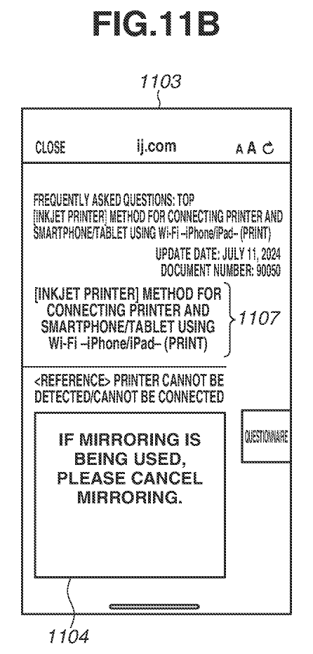

The first app may display a "preparation for connection" screen 1101 in FIG. 11A instead of displaying the "preparation for connection" screen 1003 in FIG. 10. The "preparation for connection" screen 1101 includes a link button 1102 for checking a web manual. If the link button 1102 is tapped, the first app displays a web page 1103 that includes a mirroring cancellation message 1104. The mirroring cancellation message 1104 is an example of a message prompting the user to disable the mirroring function. Further, the web page 1103 also includes a message 1107 prompting the user to cause the communication apparatus 151 to operate in the connection setting mode.

In step S909, the first app displays the "preparation for connection" screen 1003 that does not include the mirroring cancellation message 1004 in FIG. 10. Then, the first app processes the "preparation for connection" screen 1003, and the processing returns to step S905.

In step S910, the first app determines whether the OS notifies the first app of the "unknown" error. As described above, if the terminal apparatus 101 is executing the mirroring function, or if a communication apparatus 151 is not present near the terminal apparatus 101, the first app is notified of the "unknown" error. The "unknown" error is an example of a predetermined error. If it is determined that the first app is notified of the "unknown" error (YES in step S910), the processing proceeds to step S911. If it is determined that the first app is not notified of the "unknown" error (NO in step S910), the processing proceeds to step S914.

In step S911, the first app determines whether the version of the OS is a version higher than or equal to iOS 18. If the version of the OS is a version higher than or equal to iOS 18, the mirroring function is implemented. If it is determined that the version of the OS is a version higher than or equal to iOS 18 (YES in step S911), the processing proceeds to step S912. If it is determined that the version of the OS is a version lower than iOS 18 (NO in step S911), the processing of the flowchart in FIG. 9 ends. Further, the processing of the flowchart in FIGS. 3A and 3B also ends.

In step S912, the first app displays an error screen 1005 that includes a mirroring cancellation message 1006 in FIG. 10. The mirroring cancellation message 1006 is an example of a message prompting the user to disable the mirroring function. The error screen 1005 is also a screen for disabling the mirroring function and includes a "retry" button 1007 and a "cancel" button 1008. The "retry" button 1007 is a button for transmitting the instruction to establish the connection in step S905 to the OS again.

The "unknown" error occurs also in a case where a predetermined AP is not present near the terminal apparatus 101, and therefore, the error screen 1005 may include a message notifying the user to cause the communication apparatus 151 to operate in the connection setting mode, or a message notifying the user of a method for operating the communication apparatus 151 to cause the communication apparatus 151 to operate in the connection setting mode.

The first app may display an error screen 1105 in FIG. 11A instead of displaying the error screen 1005 in FIG. 10. The error screen 1105 includes a link button 1106 for checking a web manual, a "retry" button 1007, and a "cancel" button 1008. The "retry" button 1007 and the "cancel" button 1008 are similar to those in FIG. 10. If the link button 1106 is tapped, the first app displays the web page 1103 similar to the above in FIG. 11B.

The "unknown" error occurs also in a case where a predetermined AP is not present near the terminal apparatus 101, and therefore, the web page 1103 may include a message notifying the user to cause the communication apparatus 151 to operate in the connection setting mode, or a message notifying the user of a method for operating the communication apparatus 151 to cause the communication apparatus 151 to operate in the connection setting mode.

In step S913, the first app determines whether the "retry" button 1007 is tapped. If it is determined that the "retry" button 1007 is tapped (YES in step S913), the processing returns to step S905. If it is determined that the "cancel" button 1008 is tapped (NO in step S913), the processing of the flowchart in FIG. 9 ends. Further, the processing of the flowchart in FIGS. 3A and 3B also ends.

If the user disables the mirroring function of the terminal apparatus 101 according to the mirroring cancellation message 1006, there is a high possibility that a connection is successful based on a connection instruction in subsequent step S905.

In step S914, the first app determines whether the connection based on the connection instruction in step S905 is successful. Based on the connection instruction in step S905, the OS searches for a predetermined AP and displays a confirmation screen 1009 for establishing a connection between a predetermined AP enabled by the communication apparatus 151 and the terminal apparatus 101. The confirmation screen 1009 includes a "connect" button 1010 and a "cancel" button 1011. A notification regarding whether the connection is successful is received from the OS by the first app when the "connect" button 1010 is tapped on the confirmation screen 1009 displayed by the OS when a predetermined AP is found and the connection is successful. If the "cancel" button 1011 is tapped, the first app receives a notification indicating this state from the OS. If the first app receives a connection success notification based on a tap on the "connect" button 1010 from the OS (YES in step S914), the processing proceeds to step S304 in FIG. 3A. If the first app receives a cancellation notification based on a tap on the "cancel" button 1011 from the OS (NO in step S914), the processing returns to step S905.

If the connection between the predetermined AP and the terminal apparatus 101 is established based on the instruction in step S905, the processing proceeds from steps S914 to S304. Then, in steps S312 and S326 in FIGS. 3A and 3B, the first app transmits connection information for connecting to the AP 131 outside the terminal apparatus 101 and outside the communication apparatus 151 to the communication apparatus 151 through the connection between the predetermined AP and the terminal apparatus 101.

As a method for setting up the communication apparatus 151 by transmitting AP information to the communication apparatus 151, there are a first method in which the processing proceeds from step S902 to step S905, and a second method in which the processing proceeds from step S902 to step S903. The first method is a method in which the first app transmits the AP information to the communication apparatus 151. The second method is a method in which a function provided as standard in iOS transmits the AP information to the communication apparatus 151. In a case where a communication apparatus 151 is searched for by the second method, a communication apparatus 151 can be found even while the mirroring function is being executed. Communication apparatuses 151 include a communication apparatus 151 compatible with only the first method and a communication apparatus 151 compatible with both the first and second methods. In step S902 in the flowchart in FIG. 9, first, the first app searches for a communication apparatus 151 compatible with the standard setup method of iOS so that priority is given to the second method, which can be executed even while the mirroring function is being executed.

If the terminal apparatus 101 is executing the mirroring function on the terminal apparatus 121, the screens in FIG. 10 or FIGS. 11A and 11B are not displayed on the display unit 108 of the terminal apparatus 101, and are displayed on the display unit of the terminal apparatus 121.

In step S905, when the first app displays the screen 1001 indicating that a communication apparatus 151 is being searched for in FIG. 10, the first app may display the mirroring cancellation message 1004 in FIG. 10 on the screen 1001.

The "unknown" error in step S910 occurs also in a case where a predetermined AP is not present near the terminal apparatus 101, and therefore, the error screen 1005 in FIG. 10 may include a message notifying the user to cause the communication apparatus 151 to operate in the connection setting mode, or a message notifying the user of a method for operating the communication apparatus 151 to cause the communication apparatus 151 to operate in the connection setting mode.

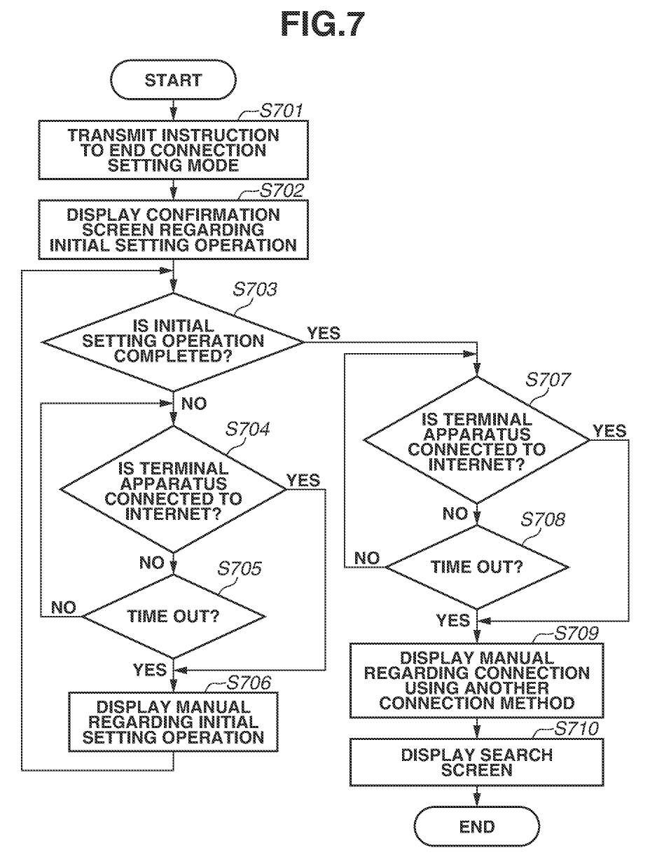

FIG. 7 is a flowchart illustrating an example of processing executed using the first app by the terminal apparatus 101 in the present embodiment. Processes in the flowchart in FIG. 7 are achieved by, for example, the CPU 103 loading the first app stored in a memory such as the ROM 104 or the like into the RAM 105 and executing the first app. The processing of this flowchart corresponds to the process of step S324.

In step S701, the first app transmits information for instructing the communication apparatus 151 to end the operation in the connection setting mode to the communication apparatus 151. Consequently, the communication apparatus 151 ends the connection setting mode and starts an operation in a mode before the communication apparatus 151 has operated in the connection setting mode again. The connection setting mode is ended, whereby the connection between the communication apparatus 151 and the terminal apparatus 101 is also disconnected. By the reconnection function of the OS, the terminal apparatus 101 connects again to the predetermined AP that is the AP to which the terminal apparatus 101 has connected before the terminal apparatus 101 has connected to the communication apparatus 151.

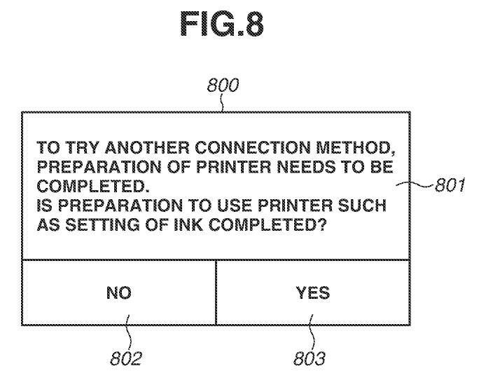

In step S702, the first app displays a confirmation screen for confirming with the user whether an initial setting operation on the communication apparatus 151 is completed. The initial setting operation on the communication apparatus 151 is an operation executed when the communication apparatus 151 is initially powered on (at the arrival of shipment). In the present embodiment, for example, the initial setting operation includes the removal of an orange tape from the communication apparatus 151, the attachment of a print head to the communication apparatus 151, the replenishment of a recording material (ink or toner) to the communication apparatus 151, the replenishment of sheets to the communication apparatus 151, the setting of the date and time in the communication apparatus 151, and the like. For example, an initial setting process that is a process executed by the communication apparatus 151 in association with the initial setting operation includes a cleaning process for cleaning the print head, the detection of a sheet, a registration process (a registration adjustment process) that is a process for adjusting the landing position of ink on a sheet in printing, the start of an operation in the connection setting mode, and the like. Thus, it can be said that the confirmation screen is a screen for confirming with the user whether the initial setting process by the communication apparatus 151 is completed. The operations included in the initial setting operation and the processes included in the initial setting process are not limited to this form, and may differ depending on the type of the communication apparatus 151, the printing method, or the like. FIG. 8 illustrates an example of the screen displayed in this process. A screen 800 includes a message 801, a "NO" button 802, and a "YES" button 803. The message 801 includes a message notifying the user that the initial setting operation on the communication apparatus 151 needs to be completed to try another connection method, and a message for confirming whether the initial setting operation on the communication apparatus 151 is completed.

If the initial setting operation on the communication apparatus 151 is completed, the user operates the "YES" button 803. If the initial setting operation on the communication apparatus 151 is not completed, the user operates the "NO" button 802.

In step S703, the first app determines whether a user operation on the "YES" button 803 is received. If a user operation on the "NO" button 802 is received, the result of this determination is NO. If the determination is YES (YES in step S703), the processing proceeds to step S707. If the determination is NO (NO in step S703), the processing proceeds to step S704.

In step S704, the first app determines whether the terminal apparatus 101 is connected to the Internet. As described above, the connection between the communication apparatus 151 and the terminal apparatus 101 is disconnected in step S701, whereby the reconnection process by the OS of the terminal apparatus 101 is executed. However, there is a case where an operation on the confirmation screen is performed before the reconnection to the AP using Wi-Fi is completed. That is, there is a case where an operation on the confirmation screen is performed in the state where the terminal apparatus 101 is not connected to the Internet through the connection using Wi-Fi with the AP. In this case, a web page cannot be displayed in the process of step S706. This determination is made to correctly display the web page in the process of step S706. In this process, specifically, the first app executes an API for checking whether the terminal apparatus 101 is connected to the Internet. Then, the first app receives from the OS a notification indicating whether the terminal apparatus 101 is connected to the Internet. Then, the first app makes this determination based on content indicated by the received notification. The notification from the OS indicates that the terminal apparatus 101 is connected to the Internet in a case where the terminal apparatus 101 is connected to the Internet through the connection using Wi-Fi with the AP.

The notification from the OS may indicate that the terminal apparatus 101 is connected to the Internet also in a case where the terminal apparatus 101 is not connected to the Internet through the connection using Wi-Fi with the AP, but is connected to the Internet through mobile data communication. The process in this determination is not limited to the above form. For example, the first app may execute an API for confirming the SSID of the AP to which the terminal apparatus 101 is currently connected, and receive from the OS a notification indicating the SSID of the AP to which the terminal apparatus 101 is currently connected. Then, if the received notification indicates an SSID different from the SSID of an AP enabled by the communication apparatus 151 operating in the connection setting mode, the determination of the first app may be YES in this determination. If the received notification indicates the SSID of the AP enabled by the communication apparatus 151 operating in the connection setting mode, the determination of the first app may be NO in this determination. That is, this determination may be the determination of whether the terminal apparatus 101 is currently connected to an AP different from the AP enabled by the communication apparatus 151 operating in the connection setting mode. If the received notification indicates the SSID of the predetermined AP, the determination of the first app may be YES in this determination. If received notification indicates an SSID different from the SSID of the predetermined AP, the determination of the first app may be NO in this determination.

If the determination is YES (YES in step S704), the processing proceeds to step S706. If the determination is NO (NO in step S704), the processing proceeds to step S705.

In step S705, the first app determines whether the time elapsed after the operation on the confirmation screen displayed in step S702 is received exceeds a predetermined threshold. That is, the first app determines whether the time elapsed after the operation on the confirmation screen displayed in step S702 is received times out. For example, the predetermined threshold is 10 seconds. If the determination is YES (YES in step S705), the processing proceeds to step S706. If the determination is NO (NO in step S705), the processing returns to step S704.

In step S706, the first app executes a process for displaying a manual regarding the initial setting operation on the communication apparatus 151. Specifically, the first app displays a web page that displays the manual regarding the initial setting operation on the communication apparatus 151 by the internal browser (an in-app browser) of the first app. Information for displaying the web page is acquired from a predetermined server through the connection to the Internet. Thus, if the communication apparatus 151 is connected to the Internet, the display of the web page is successful. If the communication apparatus 151 is not connected to the Internet, the display of the web page is not successful. Thus, a screen notifying the user that the communication apparatus 151 is not connected to the Internet is displayed by the browser. In the present embodiment, the web page is displayed by the internal browser of the first app, whereby the first app can continue to operate in the foreground. The manual regarding the initial setting operation on the communication apparatus 151 includes content that sequentially explains to the user specific operation methods for the operations to be executed as the initial setting operation on the communication apparatus 151. A form may be employed in which before displaying the web page that displays the manual regarding the initial setting operation on the communication apparatus 151, the first app displays a web page for selecting the model of the communication apparatus 151. Then, if the model is selected on this page, the manual regarding the initial setting operation corresponding to the selected model is displayed. The manual regarding the initial setting operation on the communication apparatus 151 may be displayed not by the internal browser of the first app, but by an external browser of the first app. In this case, the external browser that displays the manual transitions to the foreground, and the first app transitions to the background. The manual regarding the initial setting operation on the communication apparatus 151 may not be displayed as a web page acquired via the Internet, and may be displayed as content included in advance in the first app by the first app without using a browser. A screen displayed by the internal browser of the first app is closed by the user operating a close button on the screen.

A screen displayed by the internal browser of the first app is displayed on the confirmation screen displayed in step S702. Thus, when the screen displayed by the internal browser of the first app is closed, the terminal apparatus 101 can again accept an operation on the confirmation screen. Thus, after this process, the processing returns to step S703.

Although in the above description, a form has been employed in which if the determination result in step S705 is YES, the processing proceeds to step S706, the present disclosure is not limited to this form. If the determination result in step S705 is YES, the first app may display a message, on a screen of the first app, notifying the user that the communication apparatus 151 is not connected to the Internet or the like without attempting to display the web page using the browser.

In step S707 executed if the determination result in step S703 is YES, the first app determines whether the terminal apparatus 101 is connected to the Internet. This process is similar to that of step S704. If the determination is YES (YES in step S707), the processing proceeds to step S709. If the determination is NO (NO in step S707), the processing proceeds to step S708.

In step S708, the first app determines whether the time elapsed after the operation on the confirmation screen displayed in step S702 is received exceeds the predetermined threshold. This process is similar to that of step S705. If the determination is YES (YES in step S708), the processing proceeds to step S709. If the determination is NO (NO in step S708), the processing returns to step S707.

In step S709, the first app executes a process for displaying a manual regarding another connection method. Specifically, the first app displays a web page that displays the manual regarding another connection method by the internal browser (the in-app browser) of the first app. Information for displaying the web page is acquired from a predetermined server through the connection to the Internet. Thus, if the communication apparatus 151 is connected to the Internet, the display of the web page is successful. If the communication apparatus 151 is not connected to the Internet, the display of the web page is not successful. Thus, a screen notifying the user that the communication apparatus 151 is not connected to the Internet is displayed by the browser. In the present embodiment, the web page is displayed by the internal browser of the first app, whereby the first app can continue to operate in the foreground. The manual regarding another connection method includes content that explains a specific operation method for establishing a connection between the communication apparatus 151 and an AP using another connection method. Specifically, for example, another connection method includes a method for displaying a list of APs found by a search by the communication apparatus 151 on a screen of the communication apparatus 151 and establishing a connection using Wi-Fi between an AP selected from the displayed list by the user and the communication apparatus 151. Specifically, for example, another connection method includes a method for establishing a connection using Wi-Fi between the AP and the communication apparatus 151 based on Wi-Fi Protected Setup (WPS). Specifically, for example, another connection method includes a method for establishing a connection using a wired LAN between the AP and the communication apparatus 151 by using a wired LAN cable. A form may be employed in which before displaying the web page that displays the manual regarding the another connection method on the communication apparatus 151, the first app displays a web page for selecting the model of the communication apparatus 151. Then, if the model is selected on this page, the manual regarding another connection method corresponding to the selected model is displayed. The manual regarding another connection method for the communication apparatus 151 may be displayed not by the internal browser of the first app, but by an external browser of the first app. In this case, the external browser that displays the manual transitions to the foreground, and the first app transitions to the background. The manual regarding another connection method may not be displayed as a web page acquired via the Internet, and may be displayed as content included in advance in the first app by the first app without using a browser.

In step S710, the first app displays a search screen for searching for a communication apparatus 151 on the Wi-Fi network to which the terminal apparatus 101 is connected. The search screen is displayed underneath the internal browser in the state where the web page is displayed by the internal browser. Thus, if the internal browser is closed by operating a close button, the search screen is displayed. The search screen includes a button for instructing the first app to start searching for a communication apparatus 151 on the Wi-Fi network to which the terminal apparatus 101 is connected. If this button is pressed, the first app searches for a communication apparatus 151 on the Wi-Fi network to which the terminal apparatus 101 is connected. Then, the first app displays a list of communication apparatuses 151 found by the search. The first app displays only communication apparatuses 151 compatible with the first app among the plurality of communication apparatuses 151 found by the search. The communication apparatuses 151 compatible with the first app are communication apparatuses 151 provided by the vendor who provides the first app. Alternatively, a form may be employed in which a search is executed using a method for finding only communication apparatuses 151 provided by the vendor of the first app while excluding communication apparatuses 151 provided by another vendor. If any of the communication apparatuses 151 is selected from the displayed list, the first app acquires information regarding the selected communication apparatus 151 from the selected communication apparatus 151 via the Wi-Fi network to which the terminal apparatus 101 is connected. Then, the first app registers the selected communication apparatus 151 in the first app. Then, the processing of this flowchart ends.

Based on such a form, the first app can improve the usability of confirming the password of an AP. The first app can also improve the usability of the confirmation of another connection method.

### Other Embodiments

Although in the above embodiment, a form has been described in which a connection between the communication apparatus 151 operating in the connection setting mode and the terminal apparatus 101 is a connection using Wi-Fi, the present disclosure is not limited to this form. For example, a connection between the communication apparatus 151 operating in the connection setting mode and the terminal apparatus 101 may be established using a communication method other than Wi-Fi, such as Bluetooth® Classic, Bluetooth® Low Energy, or the like. In this case, also while the connection between the communication apparatus 151 operating in the connection setting mode and the terminal apparatus 101 is established, the terminal apparatus 101 may maintain a connection using Wi-Fi with the predetermined AP. That is, in the form in which a connection between the communication apparatus 151 operating in the connection setting mode and the terminal apparatus 101 is a connection using Wi-Fi, the predetermined AP is an AP to which the terminal apparatus 101 is connected when a process as a trigger for the start of the flowchart in FIGS. 3A and 3B is executed, but the terminal apparatus 101 is not connected when information regarding the predetermined AP is transmitted to the communication apparatus 151. On the other hand, in the form in which a connection between the communication apparatus 151 operating in the connection setting mode and the terminal apparatus 101 is a connection using a communication method other than Wi-Fi, the predetermined AP is an AP to which the terminal apparatus 101 is connected both when a process as a trigger for the start of the flowchart in FIGS. 3A and 3B is executed and when information regarding the predetermined AP is transmitted to the communication apparatus 151. Thus, it can be said that the predetermined AP is an AP to which the terminal apparatus 101 is connected at least when a process as a trigger for the start of the flowchart in FIGS. 3A and 3B is executed.

In the above embodiment, the process of referring to the particular AP may not be executed. Specifically, for example, the processes of steps S301 and S308 to S312 may be omitted. In this form, if the determination result in step S305 is NO, step S313 is executed. If the determination result in step S307 is YES, step S319 is executed.

In the above embodiment, neither the process of referring to the predetermined AP nor the process of referring to the particular AP needs to be executed. Specifically, for example, the processes of steps S301, S302, and S305 to S312 may be omitted. In this form, after step S304, step S313 is executed.

In the above embodiment, the direct connection button may not be displayed on the screen displayed in step S313. Specifically, for example, the processes of steps S314 to S317 may be omitted. In this form, after step S313, step S318 is executed.

In the above embodiment, even if the version of the OS of the terminal apparatus 101 is a version that allows the second app to display the password on the Wi-Fi setting screen, either the button 503 for confirming the password or the button 504 for another connection method may not be displayed on the password input screen displayed in step S319. That is, a form may be employed in which one of the button 503 for confirming the password and the button 504 for another connection method is displayed and the other is not displayed on the password input screen displayed in step S319. In the form in which the button 503 for confirming the password is not displayed on the password input screen displayed in step S319, steps S321 and S322 are omitted. If the determination result in step S320 is NO, step S323 is executed. In the form in which the button 504 for another connection method is not displayed on the password input screen displayed in step S319, steps S323 and S324 are omitted. If the determination result in step S321 is NO, step S325 is executed.

Although in the above embodiment, a form has been described in which the button 503 for confirming the password is displayed on the password input screen as an area for confirming the password, and if the button 503 is operated, a new screen for confirming the password is displayed; however, the present disclosure is not limited to this form. As the area for confirming the password, an area indicating text describing a specific password confirmation method may be displayed on the password input screen. That is, the content displayed on the screen for confirming the password in the above embodiment may be displayed on the password input screen. Before the password input screen is displayed, this content may be displayed on a screen that is separately and newly displayed. Then, in this form, the button 503 for confirming the password may not be displayed on the password input screen 500.

Although in the above embodiment, a form has been described in which the button 504 for another connection method is displayed on the password input screen as an area for another connection method, and if the button 504 is operated, the screen for another connection method is newly displayed, the present disclosure is not limited to this form. As the area for another connection method, an area indicating text describing another connection method may be displayed on the password input screen. That is, the content displayed on the screen for another connection method in the above embodiment may be displayed on the password input screen. Before the password input screen is displayed, this content may be displayed on a screen that is separately and newly displayed. Then, in this form, the button 504 for another connection method may not be displayed on the password input screen 500.

In the above embodiment, the order of the determinations in steps S320 to S325 is not particularly limited, and the determinations in steps S320 to S325 may be made in any order.

Although in the above embodiment, a form has been described in which the list of APs used in the determination in step S305 or the determination in step S309 or displayed in step S313 is a list of APs found by a search executed by the communication apparatus 151, the present disclosure is not limited to this form. The list of APs used in the determination in step S305 or the determination in step S309 or displayed in step S313 may be a list of APs found by a search executed by the terminal apparatus 101. In this form, the process of step S304 may be omitted.

In the above embodiment, the process of referring to information indicating whether the initial setting operation on the communication apparatus 151 is completed may not be executed. Specifically, for example, the processes of steps S702 to S706 may be omitted. In this form, after step S701, step S707 is executed.

The purpose of the present disclosure is also achieved by supplying a storage medium recording a program code of software for achieving the functions of the above embodiments to a system or an apparatus. That is, the purpose of the present disclosure is also achieved by a computer (or a CPU or a microprocessor unit (MPU)) of the system or the apparatus reading and executing the program code stored in the storage medium. In this case, the program code itself read from the storage medium achieves the functions of the above embodiments, and the storage medium storing the program code constitutes the present disclosure.

As the storage medium for supplying the program code, a flexible disk, a hard disk, an optical disc, a magneto-optical disc, a Compact Disc Read-Only Memory (CD-ROM), a Compact Disc-Recordable (CD-R), a magnetic tape, a non-volatile memory card, a ROM, a Digital Versatile Disc (DVD), or the like can be used.

A case where an OS operating on the computer or the like performs a part or all of actual processing based on an instruction from the program code, and the functions of the above embodiments are achieved by the processing is also included.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159071, filed September 13, 2024, which is hereby incorporated by reference herein in its entirety.

WHAT IS CLAIMED IS:

1. A method for controlling a first information processing apparatus including a predetermined application program and an operating system, the method comprising:
transmitting, by the predetermined application program, an instruction to the operating system to establish a connection between a communication apparatus and the first information processing apparatus;
displaying, by the predetermined application program, a screen for disabling a mirroring function, the mirroring function being a function for displaying a screen based on screen information transmitted by the first information processing apparatus and for controlling the first information processing apparatus on a display unit of a second information processing apparatus different from the first information processing apparatus; and
transmitting, by the predetermined application program, in a case where the connection between the communication apparatus and the first information processing apparatus is established based on the instruction, connection information for connecting to an access point, the access point being external to both the first information processing apparatus and the communication apparatus, to the communication apparatus via the established connection.

2. The method according to claim 1, wherein control is executed such that the screen for disabling the mirroring function is displayed based on a version of the operating system being greater than or equal to a predetermined version, and not displayed based on the version of the operating system being less than the predetermined version.

3. The method according to claim 2, wherein the operating system is iPhone Operating System (iOS), and the predetermined version is a version of the iOS.

4. The method according to claim 1, further comprising:
instructing, by the predetermined application program, the operating system to perform a search for an apparatus compatible with a standard setup function of the operating system; and
instructing, in a case where the apparatus is found by the search, from the predetermined application program, the operating system to execute the standard setup function of the operating system without transmitting the instruction to establish the connection,
wherein, in a case where the apparatus is not found by the search, the instruction to establish the connection is transmitted.

5. The method according to claim 1, wherein the screen for disabling the mirroring function is displayed while the predetermined application program is waiting to receive a result of the instruction to establish the connection from the operating system.

6. The method according to claim 1, wherein the screen for disabling the mirroring function is displayed in a case where a predetermined operation is performed on a screen that is displayed while the predetermined application program is waiting to receive a result of the instruction to establish the connection from the operating system.

7. The method according to claim 6,
wherein the instruction is to establish a connection between the communication apparatus, with a predetermined access point enabled, and the first information processing apparatus,
wherein, based on the predetermined operation being performed on the screen displayed while the predetermined application program is waiting to receive the result of the instruction to establish the connection from the operating system, and a version of the operating system being higher than or equal to a predetermined version, a screen for disabling the mirroring function and including a message prompting a user to operate the communication apparatus in a predetermined mode for enabling the predetermined access point is displayed, and
wherein, based on the predetermined operation being performed on the screen displayed while the predetermined application program is waiting to receive the result of the instruction to establish the connection from the operating system, and the version of the operating system being not higher than or equal to the predetermined version, a screen different from the screen for disabling the mirroring function and including the message prompting the user to operate the communication apparatus in the predetermined mode is displayed.

8. The method according to claim 1, wherein the screen for disabling the mirroring function is displayed based on the operating system notifying the predetermined application program of a predetermined error.

9. The method according to claim 8,
wherein, based on the operating system notifying the predetermined application program of the predetermined error, and a version of the operating system being higher than or equal to a predetermined version, a screen for disabling the mirroring function and including a message indicating that the communication apparatus is not detected is displayed, and
wherein, based on the operating system notifying the predetermined application program of the predetermined error, and the version of the operating system is not higher than or equal to the predetermined version, a screen different from the screen for disabling the mirroring function and including the message indicating that the communication apparatus is not detected is displayed.

10. The method according to claim 1, wherein the screen for disabling the mirroring function includes a message prompting a user to disable the mirroring function.

11. The method according to claim 10,
wherein the instruction is to establish a connection between the communication apparatus, with a predetermined access point enabled, and the first information processing apparatus, and
wherein the screen for disabling the mirroring function also includes a message prompting the user to operate the communication apparatus in a predetermined mode for enabling the predetermined access point.

12. The method according to claim 1, wherein the screen for disabling the mirroring function includes a link button for displaying a web page including a message prompting a user to disable the mirroring function.

13. The method according to claim 12,
wherein the instruction is to establish a connection between the communication apparatus, with a predetermined access point enabled, and the first information processing apparatus, and
wherein the web page also includes a message prompting the user to operate the communication apparatus in a predetermined mode for enabling the predetermined access point.

14. The method according to claim 1, wherein the screen for disabling the mirroring function includes a button for transmitting the instruction to establish the connection to the operating system again.

15. The method according to claim 1, wherein the communication apparatus is a printer.

16. The method according to claim 1, further comprising transmitting a print job for causing the communication apparatus to execute a printing operation.

17. The method according to claim 1, wherein the communication apparatus is a scanner.

18. The method according to claim 1, further comprising transmitting a scan job for causing the communication apparatus to execute a scanning operation.

19. An information processing apparatus including a predetermined application program and an operating system, the information processing apparatus comprising:
at least one memory and at least one processor configured to function as:
a first transmission unit configured to transmit, by the predetermined application program, an instruction to the operating system to establish a connection between a communication apparatus and the information processing apparatus;
a display unit configured to display, by the predetermined application program, a screen for disabling a mirroring function, the mirroring function being a function for displaying a screen based on screen information transmitted by the information processing apparatus and for controlling the information processing apparatus on a display unit of another information processing apparatus different from the information processing apparatus; and
a second transmission unit configured to transmit, by the predetermined application program, in a case where the connection between the communication apparatus and the information processing apparatus is established based on the instruction, connection information for connecting to an access point, the access point being external to both the information processing apparatus and the communication apparatus, to the communication apparatus via the established connection.

20. A non-transitory computer-readable storage medium storing a predetermined application program for causing a computer of an information processing apparatus including an operating system to execute:
transmitting, by the predetermined application program, an instruction to the operating system to establish a connection between a communication apparatus and the information processing apparatus;
displaying, by the predetermined application program, a screen for disabling a mirroring function, the mirroring function being a function for displaying a screen based on screen information transmitted by the information processing apparatus and for controlling the information processing apparatus on a display unit of another information processing apparatus different from the information processing apparatus; and
transmitting, by the predetermined application program, in a case where the connection between the communication apparatus and the information processing apparatus is established based on the instruction, connection information for connecting to an access point, the access point being external to both the information processing apparatus and the communication apparatus, to the communication apparatus via the established connection.
